(19) United States
(12) Patent Application Publication
(10) Pub. No.: US 2020/0167798 A1
(43) Pub. Date: May 28, 2020

(54) CUSTOMIZING CUSTOMER ONBOARDING FOR A SERVICE WITH MACHINE LEARNING MODELS

(71) Applicant: Apple Inc., Cupertino, CA (US)

(72) Inventors: Bilung Lee, San Jose, CA (US); Harish Vijendran, Sunnyvale, CA (US); Michael K. Chu, Cupertino, CA (US); Mingzhu Zhu, San Jose, CA (US); Payam Mirrashidi, Los Altos, CA (US); Wayne A. Yap, San Francisco, CA (US)

(21) Appl. No.: 16/693,752

(22) Filed: Nov. 25, 2019

Related U.S. Application Data
(60) Provisional application No. 62/771,441, filed on Nov. 26, 2018.

(51) Int. Cl. G06Q 30/00; G06Q 30/02; G06N 20/20

(52) U.S. Cl. CPC G06Q 30/016; G06N 20/20; G06Q 30/0235; G06Q 30/0236

(57) ABSTRACT

Systems, methods, and computer-readable media are provided for customizing customer onboarding for a service.

### CROSS-REFERENCE TO RELATED APPLICATION(S)

This application claims the benefit of prior filed U.S. Provisional Patent Application No. 62/771,441, filed Nov. 26, 2018, which is hereby incorporated by reference herein in its entirety.

### TECHNICAL FIELD

This disclosure relates to customizing customer onboarding for a service and, more particularly, to customizing, with machine learning models, a free trial window for a service provided to a customer and/or to customizing, with machine learning models, a timing of authorization requests for obtaining authorization from a credential manager subsystem of a credential of a customer to be used for funding a service transaction of a service between a service provider subsystem and the customer.

### BACKGROUND OF THE DISCLOSURE

A payment for funding a service transaction between a customer and a service provider (e.g., for any suitable goods/services of an online media store) using a transaction credential managed by a credential manager (e.g., a payment instrument of a financial institution) may be scheduled for authorization at a particular scheduled authorization time, and the service provider may send an authorization request for the service transaction to the credential manager at that particular scheduled authorization time. However, oftentimes, such an authorization request may detract the customer from signing-up for the service or may fail (e.g., due to downtime of the credential manager or expiration of the transaction credential) and one or more additional authorization requests may then be made.

### SUMMARY OF THE DISCLOSURE

This document describes systems, methods, and computer-readable media for customizing customer onboarding for a service.

As an example, a system is provided for onboarding of a customer for a service, where the system may include a credential manager subsystem that manages a customer transaction credential, a service provider subsystem that offers the service, and a user electronic device that attempts a new sign up for the service of the service provider subsystem, for a customer of the user electronic device, wherein the service provider subsystem is configured to customize onboarding of the customer for the service.

As another example, a method is provided for customizing onboarding of a customer for a service using a management server.

As yet another example, a non-transitory machine readable medium is provided that may store a program for execution by at least one processing unit of a management server, the program for onboarding of a customer for a service, is provided, where the program may include sets of instructions for customizing the onboarding.

As yet another example, a non-transitory computer readable storage medium is provided that may store one or more programs, the one or more programs including instructions, which, when executed by a computing system including one or more processors, may cause the computing system to customize onboarding of a customer for a service.

As yet another example, a method for customizing, using a management server, an onboarding process afforded to a customer for a service of a service provider is provided that may include running, with the management server, a trained customer service intention probability (“CSIP”) model on current CSIP onboarding feature data associated with the onboarding of the customer for the service, wherein the running the trained CSIP model predicts an intention probability that is indicative of the likelihood of the customer to use the service, running, with the management server, a trained customer service capability probability (“CSCP”) model on current CSCP onboarding feature data associated with the onboarding of the customer for the service, wherein the running the trained CSCP model predicts a capability probability that is indicative of the likelihood of the customer to pay for the service, defining, with the management server, a customized free trial length using each one of the predicted intention probability and the predicted capability probability, and providing, with the management server, a free trial of the customized free trial length to the customer for the service.

As yet another example, a system for customizing an onboarding process is provided that may include a credential manager subsystem that manages a payment credential, a service provider subsystem that offers a service, and a user electronic device that attempts to access the service of the service provider subsystem for a user of the user electronic device, wherein the user has a user account with the service provider subsystem, wherein the payment credential is associated with the user account, and wherein the service provider subsystem is configured to detect the access attempt, in response to the detection of the access attempt, run a trained learning engine on onboarding features of the access attempt to predict a likelihood of the user successfully paying for the service using the payment credential, and, when the predicted likelihood meets a likelihood threshold, automatically provide the service to the user via the user electronic device without first requesting, of the credential manager subsystem, an authorization of the payment credential for paying for the service.

As yet another example, a non-transitory machine readable medium is provided for storing a program for execution by at least one processing unit of a management server, the program for customizing an onboarding process afforded to a customer for a service, the program may include sets of instructions for predicting, using a trained first model, a likelihood of the customer using the service, predicting, using a trained second model that is different than the first model, a likelihood of the customer paying for the service, calculating a length of a trial period based on each one of the predicted likelihood of the customer using the service and the predicted likelihood of the customer paying for the service, and providing a trial of the calculated length to the customer for the service.

This Summary is provided only to present some example embodiments, so as to provide a basic understanding of some aspects of the subject matter described in this document. Accordingly, it will be appreciated that the features described in this Summary are only examples and should not be construed to narrow the scope or spirit of the subject matter described herein in any way. Unless otherwise stated, features described in the context of one example may be combined or used with features described in the context of one or more other examples. Other features, aspects, and advantages of the subject matter described herein will become apparent from the following Detailed Description, Figures, and Claims.

### BRIEF DESCRIPTION OF THE DRAWINGS

The discussion below makes reference to the following drawings, in which like reference characters refer to like parts throughout, and in which:

FIG. 1 is a schematic view of an illustrative system for customizing customer onboarding;

FIG. 2 is a more detailed schematic view of an example electronic device of the system of FIG. 1;

FIG. 3 is a front view of the example electronic device of FIGS. 1 and 2;

FIGS. 3A-3J are front views of screens of a graphical user interface of an electronic device of one or more of FIGS. 1-3 illustrating processes for customizing customer onboarding;

FIG. 4 is a more detailed schematic view of the example service provider subsystem of the system of FIG. 1;

FIG. 5 is a more detailed schematic view of an illustrative portion of the example service provider subsystem of the system of FIGS. 1 and 4; and

FIG. 6 is a flowchart of an illustrative process for customizing customer onboarding.

### DETAILED DESCRIPTION OF THE DISCLOSURE

Systems, methods, and computer-readable media may be provided for customizing customer onboarding for a service. A new layer of efficiency, effectiveness, and/or control to customer onboarding may be provided by customizing one or more aspects of an onboarding process afforded by a service provider subsystem to a particular customer for a particular service. The length of a free trial of the service that may be provided to the customer and/or under what circumstances a free trial or a to-be-paid-for portion of the service may be provided to the customer prior to authorizing a customer transaction credential may be customized. Such customization may be provided, for example, for delaying a credential authorization request during the customer onboarding process and/or for reducing or attempting to minimize the number of authorization requests made during the customer onboarding process and/or for increasing or attempting to maximize the number of successful authorization requests and/or otherwise for improving or optimizing or maximizing or increasing the success rate of each authorization request (e.g., for reducing costs associated with carrying out an authorization request) and/or for increasing or attempting to maximize the effectiveness of a free trial (e.g., to promote customer engagement and intention for retention of the service (e.g., customer decision to pay for continuation of the service)) and/or for otherwise making the onboarding process faster, more seamless, more efficient, and/or more effective. In some embodiments, customer transaction credential registration and/or authorization may be skipped prior to initiating the providing of a service or a free trial thereof to a customer during an onboarding process, for example, when a predicted likelihood of the customer to pay for the service is greater than or equal to an applicable pay threshold, where such a predicted likelihood to pay may be a result of an output from any appropriately trained model(s) using any suitable input features for the customer and/or for the service being onboarded (e.g., past history information associated with the customer (e.g., historical payment details of the customer (e.g., previous purchases and/or attempted purchases by the customer), etc.), etc.) and/or when a predicted likelihood of the customer to use the service is greater than or equal to an applicable stay threshold, where such a predicted likelihood to stay may be a result of an output from any appropriately trained model(s) using any suitable input features for the customer and/or for the service being onboarded.

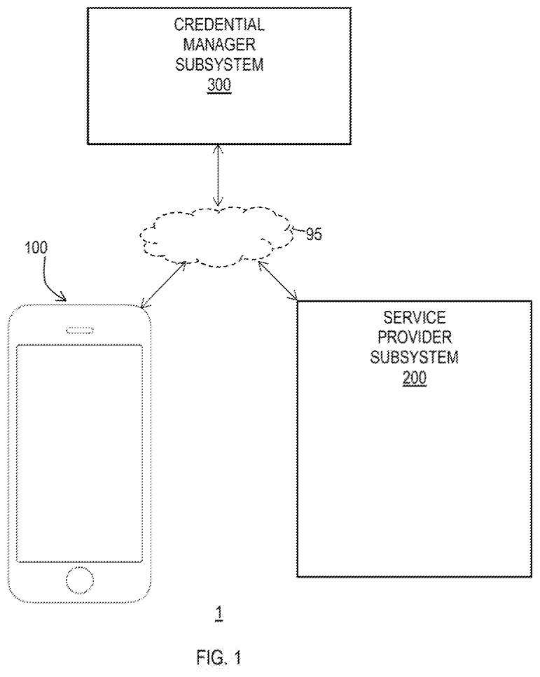

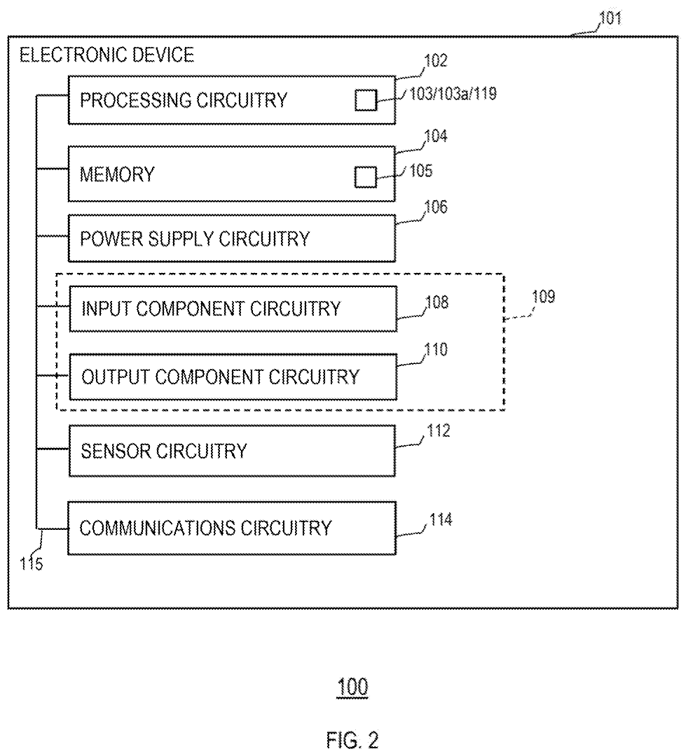

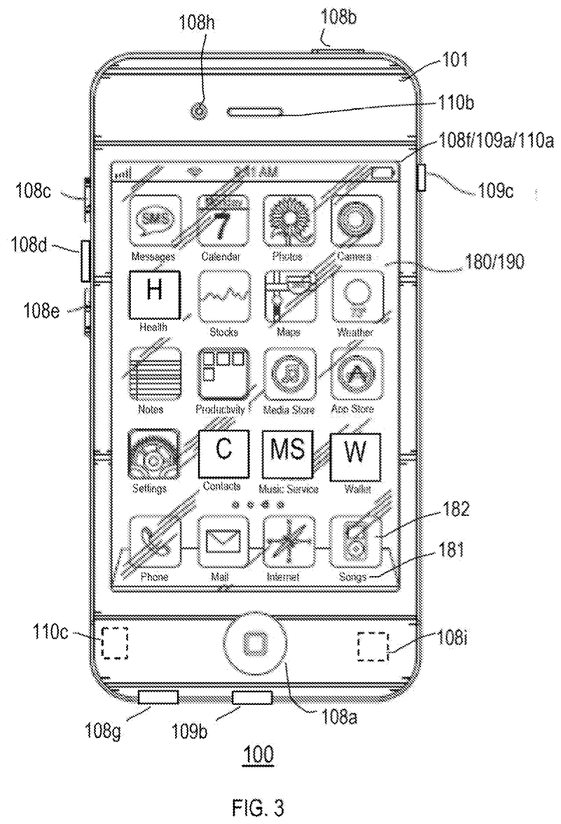

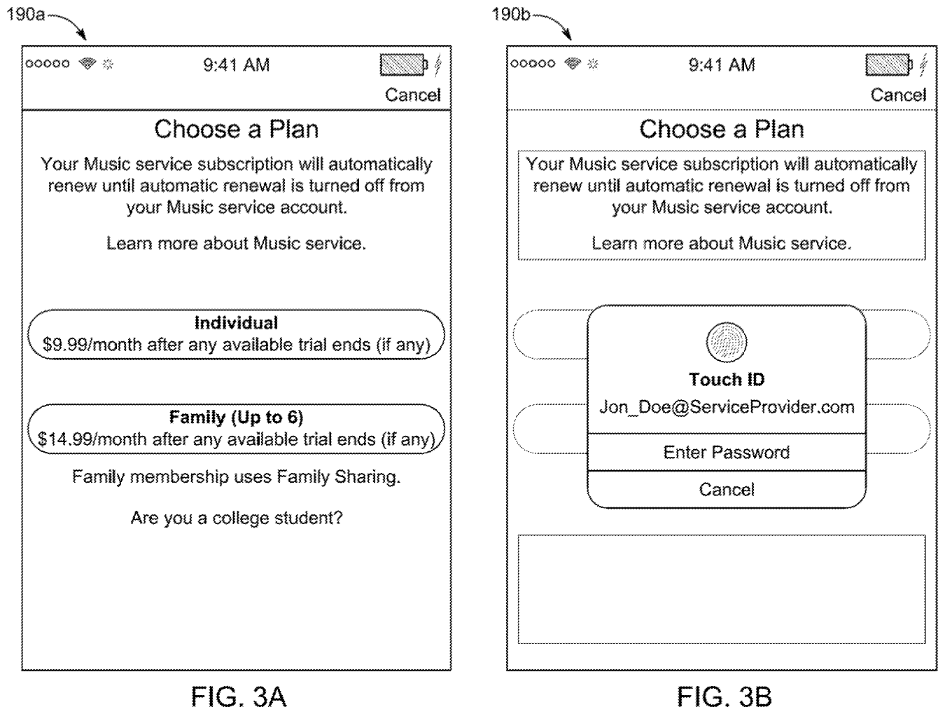

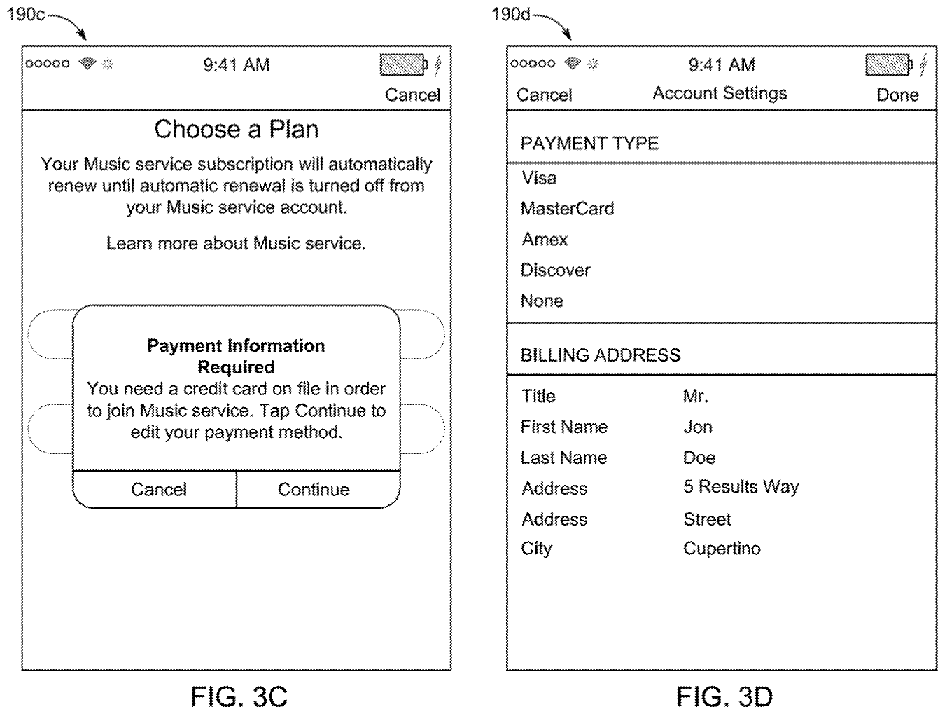

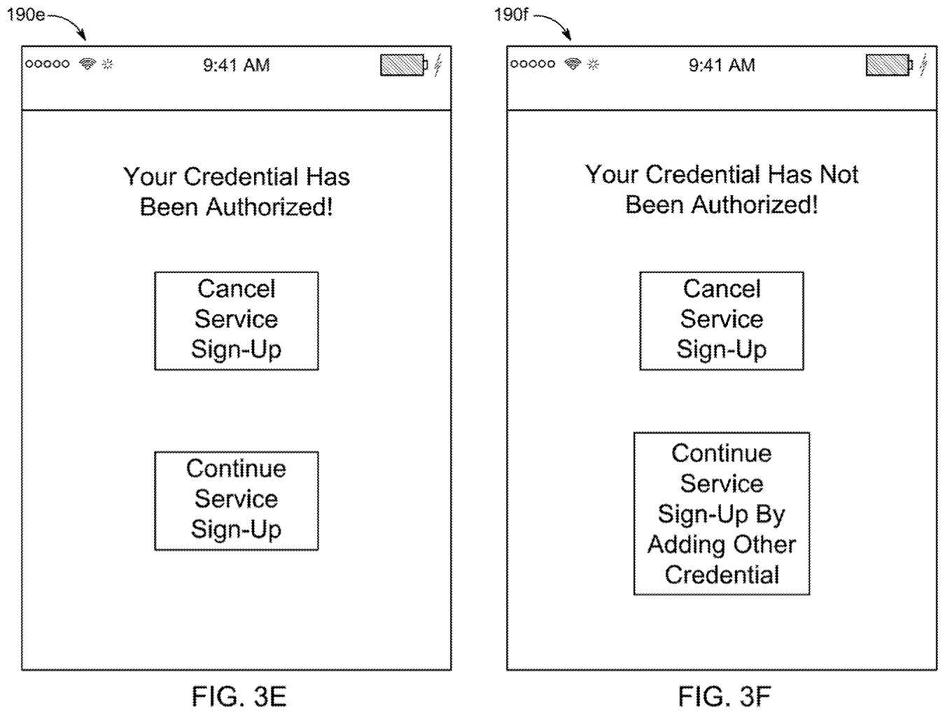

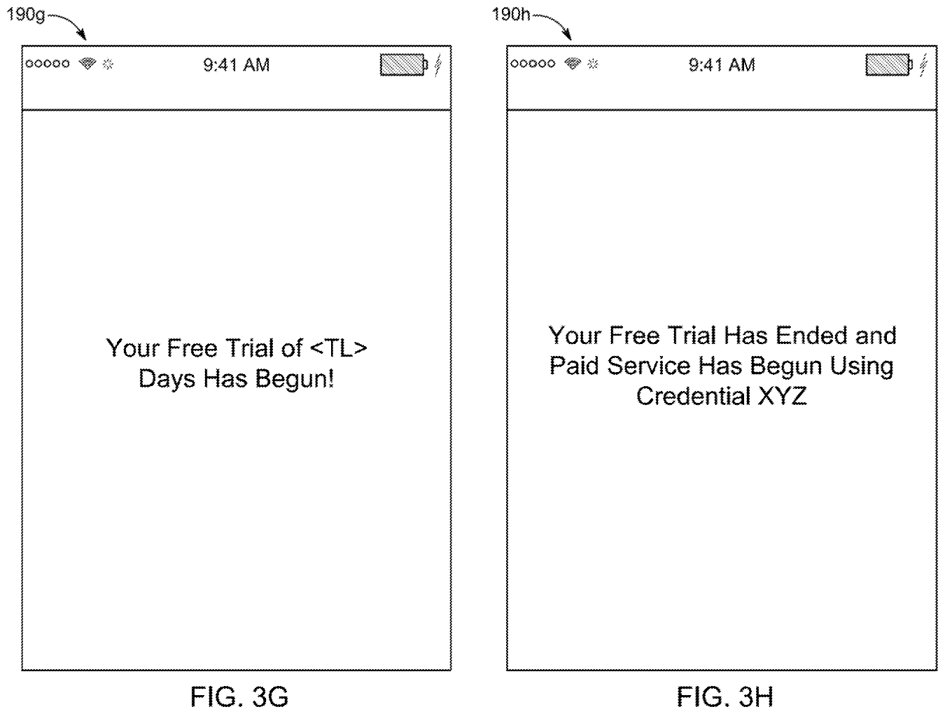

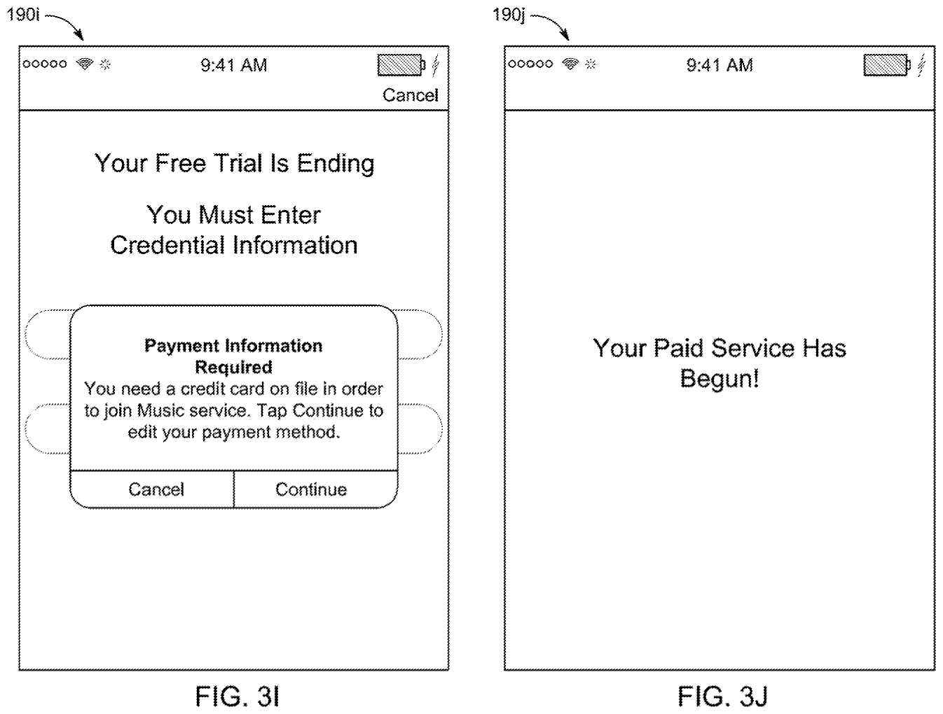

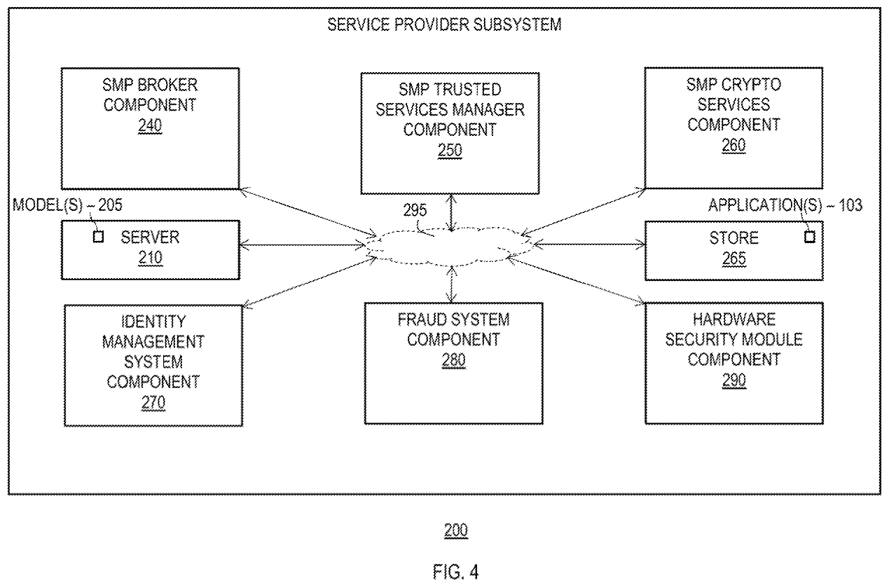

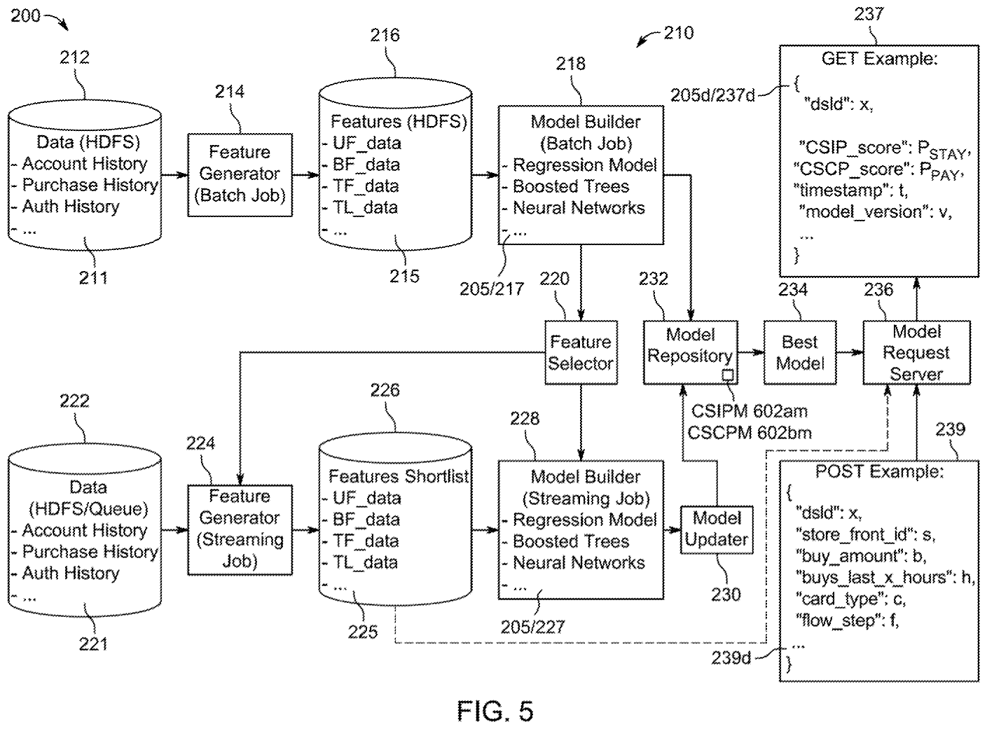

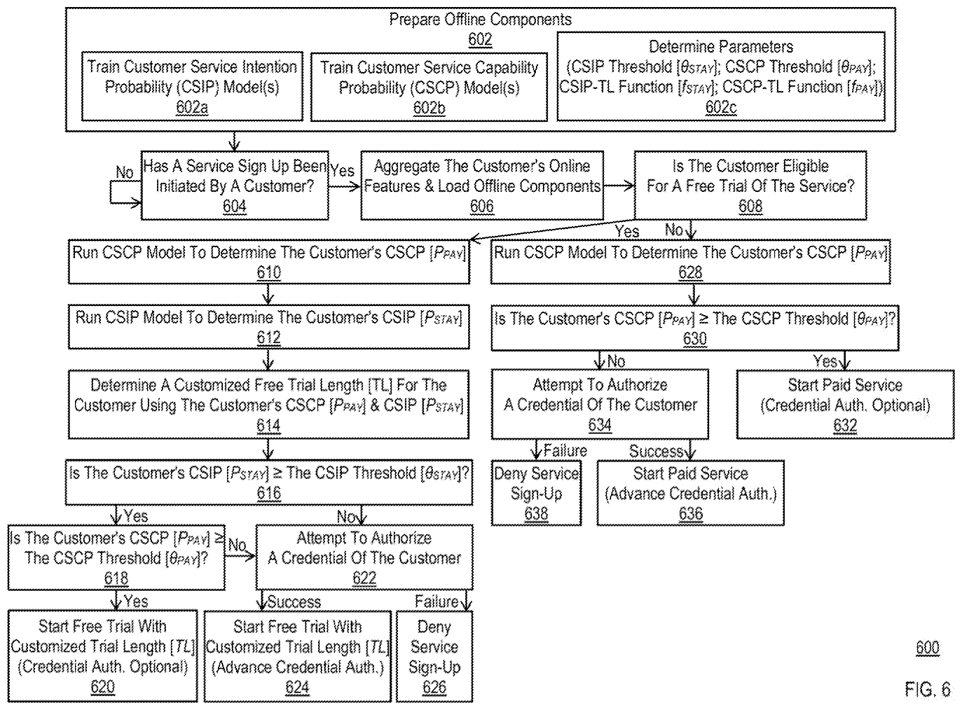

FIG. 1 shows a system 1 in which customer onboarding may be customized for defining the length of a trial window during which a user of a user electronic device 100 may have free access to a service provided by a service provider (“SP”) subsystem 200 and/or for defining when an authorization request ought to be made for authorizing the funding of a transaction for the service between service provider (“SP”) subsystem 200 and the user of user electronic device 100 using a transaction credential managed by a credential manager (“CM”) subsystem 300, while FIGS. 2 and 3 show further details with respect to particular embodiments of electronic device 100 of system 1, FIGS. 3A-3J show front views of screens of a graphical user interface of an electronic device of one or more of FIGS. 1-3 illustrating processes for customizing customer on-boarding, FIGS. 4 and 5 show further details with respect to particular embodiments of SP subsystem 200 of system 1, and FIG. 6 is a flowchart of an illustrative process for customizing customer on-boarding.

### Description of FIG. 1

FIG. 1 is a schematic view of an illustrative system 1 that may allow for customization of onboarding of a customer (e.g., a user of electronic device 100) for a service of SP subsystem 200, such as by customizing a free trial window for the service provided to the customer and/or by customizing a timing of when an authorization request ought to be made for authorizing the funding of a service transaction between SP subsystem 200 and the customer using a customer transaction credential managed by CM subsystem 300. When a customer attempts to sign up for a service of the SP (e.g., for one or more goods or services of the SP (e.g., SP product)), it may be determined whether the customer is eligible for a free trial of that service. If the customer is determined to be eligible for such a free trial, it may be determined whether or not such a free trial ought to be initiated for the customer prior to requesting authorization of a customer transaction credential (e.g., credit card credential, debit card credential, loyalty card credential, stored value credential, etc.) that may be managed by CM subsystem 300 (e.g., a financial institution subsystem) for use by the customer in order to pay for the service once the free trial expires, and a length of such a free trial may be customized for the customer for increasing or attempting to maximize the effectiveness of such a free trial (e.g., to promote customer engagement and intention for retention of the service (e.g., customer decision to pay for continuation of the service)). However, if the customer is determined not to be eligible for such a free trial, it may be determined whether or not the service ought to be provided to the customer prior to requesting authorization of the customer transaction credential that may be used by the customer in order to pay for the service. SP subsystem 200 may communicate to CM subsystem 300 a customer transaction credential authorization request with any suitable credential authorization request data that may be indicative of the customer transaction credential to be authorized. Such credential authorization request data may include data indicative of the customer transaction credential (e.g., a hashed or complete personal account number and/or expiration date and/or billing address and/or card verification value (“CVV”), etc.) as well as data indicative of the total amount of funds required from a funding account associated with the customer transaction credential (e.g., an account managed by CM subsystem 300 on behalf of the customer) in order to fund any suitable service transaction (e.g., a first month of a monthly subscription service, etc.), as well as any suitable additional transaction information indicative of the transaction, such as a limited transaction descriptor that may be indicative of the identity of SP subsystem 200, and/or of the goods or services being purchased, and/or the like. CM subsystem 300 may use such credential authorization request data to determine whether or not to approve or decline the customer transaction credential for use in funding such a service transaction (e.g., at that time or at any suitable time in the future), where such funding may involve transfer of funds from the funding account associated with the customer transaction credential to an account associated with SP subsystem 200 (e.g., to fund the service transaction on behalf of the customer).

A credential authorization request may be declined by CM subsystem 300 or otherwise unsuccessful for any suitable reason, such as CM subsystem 300 being temporarily offline, the customer transaction credential being temporarily suspended, the customer transaction credential being invalid (e.g., due to the expiration date of the credential having been passed), and/or the like. Moreover, each credential authorization request made by SP subsystem 200 may have any suitable cost associated therewith, including, but not limited to, an operational cost, a transactional cost, and/or the like, to which a particular monetary value may be calculated or used to represent the cost to SP subsystem 200 of a credential authorization request. Moreover, carrying out such a credential authorization request may take a certain amount of time to complete, which may detract the customer from signing-up for the service and result in a failed onboarding. Moreover, creation of a credential authorization request may require a customer to provide certain information regarding the customer transaction credential to be authorized (e.g., manually entering or selecting some or all credential identification information for enabling the authorization request), which may detract the customer from signing-up for the service and result in a failed onboarding. Therefore, a goal of customizing a customer onboarding process may be to delay a credential authorization request during the customer onboarding process and/or to reduce or attempt to minimize the number of authorization requests made during the customer onboarding process and/or to increase or attempt to maximize the number of successful authorization requests and/or otherwise to improve or optimize or maximize or increase the success rate of each authorization request (e.g., for reducing costs associated with carrying out an authorization request) and/or to customize a free trial length to increase or attempt to maximize the effectiveness of such a free trial (e.g., to promote customer engagement and intention for retention of the service (e.g., customer decision to pay for continuation of the service)) and/or to otherwise make the onboarding process faster, more seamless, more efficient, and/or more effective.

A determination of whether or not to carry out a customer transaction credential authorization request and/or a determination of a free trial window length may be made based on various types of information, including, but not limited to a probability of customer payment or a customer service capability probability (“CSCP”) or P_{PAY}, a probability of customer retention or a customer service intention probability (“CSIP”) or P_{STAY}, and/or the like. One or more machine learning models may be trained and later used to determine such information for a particular customer being onboarded for a particular service. For example, one or more CSCP models may be trained and utilized for predicting or otherwise determining the probability of customer payment CSCP or P_{PAY} by a particular customer being onboarded for a particular service, while one or more CSIP models may be trained and utilized for predicting or otherwise determining the probability of customer intention for retention CSIP or P_{STAY} of a particular customer being onboarded for a particular service. Such predicted probabilities may be used to determine whether or not to provide a free trial window for the service to the customer prior to authorizing a customer transaction credential and/or to determine a customized length of such a free trial window and/or to determine whether or not to provide any portion of the service (e.g., of a service to be paid for) to the customer prior to authorizing a customer transaction credential, for customizing the onboarding process for the particular customer (e.g., for simplifying process and/or for making the process more efficient and/or effective and/or for increasing the rate at which a customer is retained during the onboarding process and/or for increasing the length of time during which the customer is onboarded with the service and/or for increasing the number of customers onboarded with successfully deferred customer transaction credential authorization and/or the like).

Various types of data may be used to predict or otherwise determine the probability of customer payment CSCP or P_{PAY} by a particular customer being onboarded for a particular service. For example, at least one suitable CSCP model, such as any suitable machine learning model (e.g., a binary classification model, a multi-class classification model, a regression model, a random forest model, a gradient boosted tree model, an ensemble model, a neural network (e.g., a deep or wide or deep and wide neural network), a learning engine, models that are non-machine learning models or non-statistical learning based models, where such engines may include policy- or operations-based rules, third party learning application programming interfaces (“APIs”), and/or the like), may be trained and/or utilized by SP subsystem 200 or any other suitable entity in conjunction with any suitable onboarding data for determining whether or not to carry out a customer transaction credential authorization request or for otherwise customizing customer onboarding for a particular customer and/or a particular service. For example, as described with respect to FIGS. 4-6, any suitable CSCP model(s) may be trained (e.g., offline) (e.g., at operation 602b of process 600 of FIG. 6) in conjunction with any suitable number of sets of any suitable historical service onboarding data that may be indicative of any suitable features or categories or characteristics of one or more previous service onboardings carried out for a particular service (or various services) for any customers (e.g., a successful or unsuccessful customer onboarding), and the eventual success or failure of charging the customer for using the service of the onboarding of the set may be used as the truth (e.g., ground truth) for the training set for the CSCP model, where such a set of onboarding data for a particular onboarding for a particular service for a particular customer may be indicative of any suitable characteristics, features (e.g., model input features), or categories of the onboarding, including, but not limited to, time features (“TF”), billing features (“BF”), user features (“UF”), and/or the like.

Various types of data may be used to predict or otherwise determine the probability of customer intention CSIP or P_{STAY} for a particular customer being onboarded for a particular service. For example, at least one suitable CSIP model, such as any suitable machine learning model (e.g., a binary classification model, a multi-class classification model, a regression model, a random forest model, a gradient boosted tree model, an ensemble model, a neural network (e.g., a deep or wide or deep and wide neural network), a learning engine, models that are non-machine learning models or non-statistical learning based models, where such engines may include policy- or operations-based rules, third party learning APIs, and/or the like), may be trained and/or utilized by SP subsystem 200 or any other suitable entity in conjunction with any suitable onboarding data for determining whether or not to carry out a customer transaction credential authorization request or for otherwise customizing customer onboarding for a particular customer and/or a particular service. For example, as described with respect to FIGS. 4-6, any suitable CSIP model(s) may be trained (e.g., offline) (e.g., at operation 602a of process 600 of FIG. 6) in conjunction with any suitable number of sets of any suitable historical service onboarding data that may be indicative of any suitable features or categories or characteristics of one or more previous service onboardings carried out for a particular service (or various services) for any customers (e.g., a successful or unsuccessful customer onboarding), and the eventual success or failure of retaining the customer for using the service (e.g., after any free trial window) of the onboarding of the set may be used as the truth (e.g., ground truth) for the training set for the CSIP model, where such a set of onboarding data for a particular onboarding for a particular service for a particular customer may be indicative of any suitable characteristics, features (e.g., model input features), or categories of the onboarding, including, but not limited to, any suitable time features, billing features, user features, and/or the like (e.g., as described with respect to the CSCP model(s)).

Such time input features for a particular onboarding for a particular service for a particular customer of a particular service onboarding data set, which may be used to train one or more CSIP models and/or one or more CSCP models and/or used as inputs to determine a probability from one or more CSIP models and/or one or more CSCP models, may include any suitable features, including, but not limited to, time of day and/or day of week and/or day of month and/or month of year of any suitable event(s) of the onboarding (e.g., the moment that a periodic subscription service is due to be up for renewal, the moment that a free trial period for the service of the onboarding ends and initial payment for the service of the onboarding is due, etc.), time of day and/or day of week and/or day of month and/or month of year of a transaction funding authorization request associated with funding of the service of the onboarding, time of day and/or day of week and/or day of month and/or month of year of a customer transaction credential authorization request associated with a customer transaction credential of the onboarding, an amount of time between a transaction due date and an authorization request of the onboarding, an amount of time between a transaction due date and a transaction funding authorization request, time since last authorization success, time since last authorization failure, time since last activity, time since last billing information update, maximum duration of stay on any particular paid subscription, and/or the like.

Such billing input features for a particular onboarding for a particular service for a particular customer of a particular service onboarding data set, which may be used to train one or more CSIP models and/or one or more CSCP models and/or used as inputs to determine a probability from one or more CSIP models and/or one or more CSCP models, may include any suitable features, including, but not limited to, amount of time that any customer transaction credential associated with the customer has been tracked by or otherwise also on record at the SP subsystem (e.g., for the particular service onboarding or for any other purpose (e.g., any other service)), the type of such a customer transaction credential (e.g., store credit, credit card, debit card, etc.), the CM subsystem responsible for such a customer transaction credential, the expiration date of such a customer transaction credential, the personal account number (hashed or otherwise) of such a customer transaction credential, number of times a customer has updated at the SP subsystem the billing information associated with such a customer transaction credential, the amount of time since the last time the customer updated at the SP subsystem the billing information associated with such a customer transaction credential, the type of billing error associated with an authorization request if it was unsuccessful (e.g., credential declined, credential delinquent, network problem (e.g., CM subsystem was offline), etc.) for such a customer transaction credential, number and/or time(s) and/or funding value of any or each previously attempted and failed authorization requests made for such a customer transaction credential, number and/or time(s) and/or funding value of any or each previously attempted and successful authorization requests made for such a customer transaction credential, duration since last authorization failure/success for such a customer transaction credential, status of last authorization request for such a customer transaction credential, amount of last authorization request for such a customer transaction credential, ratio of free versus paid purchases for such a customer transaction credential, ratio of failed versus successful authorization requests made for such a customer transaction credential, number of first authorization attempt failure/success for such a customer transaction credential, maximum number of authorization attempts on a transaction for such a customer transaction credential, number of distinct users associated with such a customer transaction credential at the SP and/or with an account at the SP including that customer transaction credential, number of distinct device platforms associated with such a customer transaction credential at the SP and/or with an account at the SP including that customer transaction credential, number of distinct customer transaction credentials associated with the customer and on record at the SP subsystem, number of distinct types of customer transaction credentials associated with the customer and on record at the SP subsystem, number of distinct CM subsystems responsible for the customer transaction credentials associated with the customer and on record at the SP subsystem, age (e.g., average, minimum, maximum, etc.) of customer transaction credentials associated with the customer and on record at the SP subsystem, amount spent (e.g., average, minimum, maximum, etc.) on various products (e.g., subscription, songs, books, etc.) of the SP subsystem for each of the customer transaction credentials associated with the customer and on record at the SP subsystem, number of distinct product types purchased with each or such a particular customer transaction credential, number of distinct product types obtained for free, number of distinct products purchased with each or such a particular customer transaction credential, price (e.g., average, minimum, maximum, etc.) of all products purchased and/or otherwise obtained with each or such a particular customer transaction credential, price (e.g., average, minimum, maximum, etc.) and/or amount of products purchased and/or otherwise obtained of a particular type (e.g., server storage type (e.g., iCloud™), music type, inApp, etc.), status of last authorization request for such a customer transaction credential, type of last SP product purchased with such a customer transaction credential, cost of last SP product purchased with such a customer transaction credential, and/or the like.

Such user input features for a particular onboarding for a particular service for a particular customer of a particular service onboarding data set, which may be used to train one or more CSIP models and/or one or more CSCP models and/or used as inputs to determine a probability from one or more CSIP models and/or one or more CSCP models, may include any suitable features, including, but not limited to, family status of customer (e.g., with respect to the SP (e.g., family member, shared family plan, individual customer, etc.)), length of customer association with the SP product associated with the onboarding (e.g., days the customer has been subscribed to or using a service of the onboarding and/or of any other service of the SP), length of customer association with the SP associated with the onboarding days the customer has had an account with the SP (e.g., account tenure)), device platform used by the customer (e.g., device platform of device 100), customer identifier (e.g., unique ID of the customer consumer or of a family or consumer group that may include the customer), a subscription price for a service of the onboarding, a subscription length for a service of the onboarding, a subscription gap (e.g., length of time in between subscriptions) by the customer for the service of the onboarding, a maximum number of subscriptions held by the customer, a total amount in age and/or cost and/or number of subscriptions of the customer, an average amount in age and/or cost and/or number of subscriptions of the customer, a maximum amount in age and/or cost and/or number of subscriptions of the customer, a minimum amount in age and/or cost and/or number of subscriptions of the customer, a total amount of activity carried out by the customer with respect to a service (e.g., a service of the onboarding or otherwise of the SP) and/or with respect to each service of the SP, a minimum amount of activity carried out by the customer with respect to a service (e.g., a service of the onboarding or otherwise of the SP) and/or with respect to each service of the SP, a maximum amount of activity carried out by the customer with respect to a service (e.g., a service of the onboarding or otherwise of the SP) and/or with respect to each service of the SP, an average amount of activity carried out by the customer with respect to a service (e.g., a service of the onboarding or otherwise of the SP) and/or with respect to each service of the SP, a total amount of length of time of activity carried out by the customer with respect to a service (e.g., a service of the onboarding or otherwise of the SP) and/or with respect to each service of the SP, a minimum amount of length of time of activity carried out by the customer with respect to a service (e.g., a service of the onboarding or otherwise of the SP) and/or with respect to each service of the SP, a maximum amount of length of time of activity carried out by the customer with respect to a service (e.g., a service of the onboarding or any other service or otherwise of the SP) and/or with respect to each service of the SP, an average amount of length of time of activity carried out by the customer with respect to a service (e.g., a service of the onboarding or any other service or otherwise of the SP) and/or with respect to each service of the SP, number of repeated activity of a type carried out by the customer with respect to a service (e.g., a service of the onboarding or any other service or otherwise of the SP) and/or with respect to each service of the SP, information indicative of any suitable customer engagement with the SP product associated with the transaction (e.g., number of songs played by the customer using a subscription music streaming service of the onboarding and/or of any other service of the SP, etc.), location of the customer, amount spent on various products (e.g., subscription, songs, books, etc.) for the customer, duration since last authorization failure/success for the customer, ratio of free versus paid purchases for the customer, number of first authorization attempt failure/success for the customer, maximum number of authorization attempts on a transaction for the customer, and/or the like.

Each CSCP model may be trained using any suitable input features of any suitable historic onboarding training data set (e.g., any suitable CSCP onboarding feature data) via any suitable supervised approach (e.g., logistic regression, random forest, gradient boosted decision trees, deep learning (e.g., long short term memory (“LSTM”)), and/or the like) as well as developed (e.g., at operation 602b of process 600 of FIG. 6) using the eventual success or failure of collecting the requisite funds from the customer for making the requisite customer payment for the service of the historic onboarding process of the historic onboarding training data set (e.g., success or failure of getting an authorized payment from the customer for the service) as the truth (e.g., ground truth) for the training set (e.g., a ground truth of value 1 for success and a around truth of value 0 for failure) such that the trained CSCP model may be used for outputting a probability of customer payment or a CSCP or a P_{PAY}. For example, a CSCP model may be trained to output such a customer service capability probability (CSCP) score P_{PAY} with any suitable value of any suitable scale (e.g., a value between 0 (e.g., indicative of a 0% chance of successful customer payment for the particular service being onboarded) and 1 (e.g., indicative of a 100% chance of successful customer payment for the particular service being onboarded)) for a particular onboarding of a particular customer for a particular service using any suitable model input features of that onboarding. Then, such a CSCP model may be used (e.g., online) (e.g., at operation 610 and/or operation 628 of process 600 of FIG. 6) to predict or otherwise determine such a probability of customer payment or a CSCP or a P_{PAY} for a particular onboarding currently underway for a particular service for a particular customer (e.g., using any suitable CSCP onboarding feature data for the particular customer and service (e.g., as may be aggregated at operation 606 (e.g., TF, BF, UF data) and/or operation 608 (e.g., TL data)) as input feature data to the model(s)). Such a predicted P_{PAY} probability generated by a CSCP model may be indicative of the capability of the customer to pay for the service (e.g., how likely is the customer to be able to pay for the service successfully (e.g., after any provided free trial period (if any))).

Each CSIP model may be trained using any suitable input features of any suitable historic onboarding training data set (e.g., any suitable CSIP onboarding feature data) via any suitable supervised approach (e.g., logistic regression, random forest, gradient boosted decision trees, deep learning (e.g., LS″), and/or the like) as well as developed (e.g., at operation 602a of process 600 of FIG. 6) using the eventual success or failure of converting the historic onboarding process of the historic onboarding training data set (e.g., success or failure of getting the customer to use the service of the onboarding (e.g., after any free trial period of the onboarding)) as the truth (e.g., ground truth) for the training set (e.g., a ground truth of value 1 for success and a ground truth of value 0 for failure) such that the trained CSIP model may be used for outputting a probability of customer intention or a CSIP or a P_{STAY}. For example, a CSIP model may be trained to output such a customer service intention probability (CSIP) score P_{STAY} with any suitable value of any suitable scale (e.g., a value between 0 (e.g., indicative of a 0% chance of successful customer retention for customer use of the particular service being onboarded) and 1 (e.g., indicative of a 100% chance of successful customer retention for customer use of the particular service being onboarded)) for a particular onboarding of a particular customer for a particular service using any suitable model input features of that onboarding. Then, such a CSIP model may be used (e.g., online) (e.g., at operation 612 of process 600 of FIG. 6) to predict or otherwise determine such a probability of customer intention or retention or a CSIP or a P_{STAY} for a particular onboarding currently underway for a particular service for a particular customer (e.g., using any suitable CSIP onboarding feature data for the particular customer and service (e.g., as may be aggregated at operation 606 (e.g., IF, BF, OF data) and/or operation 608 (e.g., TL data)) as input feature data to the model(s)). Such a predicted probability generated by a CSIP model may be indicative of the willingness of the customer to use the service (e.g., the willingness of the customer to pay for the service (e.g., how likely is the customer to stay with the service (e.g., after any provided free trial period (if any)))).

In some embodiments, a particular type of input feature for training a CSCP model and/or for training a CSIP model may include trial length (“TL”) input feature data of the historical onboarding data, which may be indicative of a length of a free trial window provided to the particular customer during which the customer may access for free (e.g., without paying for) a portion or the entirety of the service's offerings of the particular service of the particular onboarding. In some embodiments (e.g., after certain types of iterations of onboarding processes), one or more CSIP models and/or one or more CSCP models may also be trained on free trial window length TL input feature data (e.g., once enough historical onboarding data sets have been accumulated for onboarding processes using customized or otherwise varied free trial lengths for a particular service). For example, a first CSCP model may be trained on input feature data of historic onboarding training data sets associated with historical onboarding(s) including a free trial window length of a first free trial window length or a first range of lengths L1, a second CSCP model may be trained on input feature data of historic onboarding training data sets associated with historical onboarding(s) including a free trial window length of a second free trial window length or a second range of lengths L2 different from L1, and so on, such that different CSCP models may be associated with different free trial lengths or ranges thereof (e.g., a first trial window length of 0 days, a second trial window length of greater than days but less than 1 day, a third trial window length of greater than 1 day but less than 2 days, or the like (e.g., a first trial window length of 0 time, a second trial window length of 1 day to 7 days, a third trial length of 7 days to 14 days, etc.)). Each CSCP model may be trained via any suitable supervised approach and developed (e.g., at operation 602b of process 600 of FIG. 6) for use in determining (e.g., at operation 610 and/or operation 628 of process 600 of FIG. 6) a particular capability probability (e.g., a discrete class or continuous numerical value) generally (e.g., using a CSCP model not trained with a trial window length as an input feature) or for each possible free trial length that ought to be considered or possible for the service for which the customer is being onboarded (e.g., using each one of a number of different CSCP models, each trained on historical onboarding data with a respective trial window length of a particular length or range thereof as an input feature). Additionally or alternatively, a first CSIP model may be trained on input feature data of historic onboarding training data sets associated with historical onboarding(s) including a free trial window length of a first free trial window length or a first range of lengths L1, a second CSIP model may be trained on input feature data of historic onboarding training data sets associated with historical onboarding(s) including a free trial window length of a second free trial window length or a second range of lengths L2 different from L1, and so on, such that different CSIP models may be associated with different free trial lengths or ranges thereof (e.g., a first trial window length of 0 days, a second trial window length of greater than 0 days but less than 1 day, a third trial window length of greater than 1 day but less than 2 days, or the like (e.g., a first trial window length of 0 time, a second trial window length of 1 day to 7 days, a third trial length of 7 days to 14 days, etc.)). Each CSIP model may be trained via any suitable supervised approach and developed (e.g., at operation 602a of process 600 of FIG. 6) for use in determining (e.g., at operation 612 of process 600 of FIG. 6) a particular intention probability (e.g., a discrete class or continuous numerical value) generally (e.g., using a CSIP model not trained with a trial window length as an input feature) or for each possible free trial length that ought to be considered or possible for the service for which the customer is being onboarded (e.g., using each one of a number of different CSIP models, each trained on historical onboarding data with a respective trial window length of a particular length or range thereof as an input feature).

Therefore, a CSCP or P_{PAY} may be identified for each potential free trial window length of a current onboarding process using a CSCP model associated with (e.g., trained on user input feature data including) that respective free trial window length, such that different CSCPs or P_{PAYS} may be determined for different possible free trial lengths for the current onboarding process, or a general CSCP or P_{PAY} may be determined for a current onboarding process using a general CSCP model (e.g., a CSCP model not trained on input feature data of historic onboarding training data sets associated with historical onboarding(s) including a particular free trial window length). A CSCP model may be trained to output a customer service capability probability (CSCP) score P_{PAY} (e.g., a value between 0 (e.g., indicative of a 0% chance of successful customer payment for the particular service being onboarded) and 1 (e.g., indicative of a 100% chance of successful customer payment for the particular service being onboarded)) for a particular current onboarding of a particular customer for a particular service using any suitable model input features of that onboarding, either generally (e.g., if a free trial window length is not to be customized and/or if specific trial window length models are not available) or for each one of any suitable potential free trial window lengths or ranges thereof (e.g., a particular CSCP model (e.g., a CSCPM 602bm of FIG. 5) may be trained to provide a model function m_{PAY} (TF, BF, UF, TL)=P_{PAY}(TL) for a particular free trial window length or range TL or a general CSCP model (e.g., a CSCPM 602bm of FIG. 5) may be trained to provide a model function m_{PAY} (TF, BF, UF)=P_{PAY} (e.g., when a free trial window length is not to be customized and/or if specific trial window length models are not available)). Each CSCP model may be trained to model a function m_{PAY} using any suitable supervised approach, including, but not limited to, logistic regression, random forest, gradient boosted decision trees, deep learning (e.g., LSTM), and/or the like. However, in order to train such a CSCP model using historical onboarding data as model input features, accurate model outputs or model labels must first be determined for use in such training (e.g., by identifying the result of the historical onboardings used to train the model). Additionally or alternatively, therefore, a CSIP or P_{STAY} may be identified for each potential free trial window length of a current onboarding process using a CSIP model associated with (e.g., trained on user input feature data including) that respective free trial window length, such that different CSIPs or P_{STAYS} may be determined for different possible free trial lengths for the current onboarding process, or a general CSIP or P_{STAY} may be determined for a current onboarding process using a general CSIP model (e.g., a CSIP model not trained on input feature data of historic onboarding training data sets associated with historical onboarding(s) including a particular free trial window length). A CSIP model may be trained to output a customer service capability probability (CSIP) score P_{STAY} (e.g., a value between 0 (e.g., indicative of a 0% chance of successful customer intention for retention for the particular service being onboarded) and 1 (e.g., indicative of a 100% chance of successful customer intention for retention for the particular service being onboarded)) for a particular onboarding of a particular customer for a particular service using any suitable model input features of that onboarding, either generally (e.g., if a free trial window length is not to be customized and/or if specific trial window length models are not available) or for each one of any suitable potential free trial window lengths or ranges thereof (e.g., a particular CSIP model (e.g., a CSIPM 602am of FIG. 5) may be trained to provide a model function m_{STAY} (TF, UF, TL)=P_{STAY}(TL) for a particular free trial window length or range TL or a general CSIP model (e.g., a CSIPM 602am of FIG. 5) may be trained to provide a model function m_{STAY} (TF, UF)=P_{STAY} (e.g., when a free trial window length is not to be customized and/or if specific trial window length models are not available)). Each CSIP model may be trained to model function m_{STAY} using any suitable supervised approach, including, but not limited to, logistic regression, random forest, gradient boosted decision trees, deep learning (e.g., LSTM), and/or the like. However, in order to train such a CSIP model using historical onboarding data as model input features, accurate model outputs or model labels must first be determined for use in such training (e.g., by identifying the result of the historical onboardings used to train the model). A CSIP model and a CSCP model may be different in any one, some, or each of various suitable areas, including, but not limited to, features, truths (e.g., labels), algorithms, and/or the like. For example, activity may be a feature specific to a CSIP model while online billing may be a feature specific to a CSCP model. As another example, for a CSIP model, a positive truth (or success) may be when a user continues using the service after a given range, while, for a CSCP model, a positive truth (or success) may be when a user makes a payment within a given range. As yet another example, algorithms may or may not be the same between a CSIP model and a CSCP model, for example, depending on online/offline model selection and/or tuning.

In some embodiments, certain characteristics of a customized onboarding process may be dynamically changed during the pendency of that onboarding process based on new real-time data that may be made available to the system. For example, a free trial length of a free trial period of a customized onboarding process may be dynamically updated by re-training and/or re-inferring any suitable CSIP model and/or any suitable CSCP model during the onboarding process using any new data that may be made available to the system during that onboarding process. As just one example, while a free trial period may be actively being provided for a particular customer's onboarding process for a particular service (e.g., as may have been determined at least partially by the output(s) of one or more CSIP model(s) and/or by the output(s) of one or more CSCP models(s)), in response to a negative result of any authorization request and/or in response to the particular customer attempting to make a new purchase or otherwise changing any suitable online customer feature data, new onboarding process data may be created that may be used by the system for potentially dynamically updating one or more characteristics of the onboarding process (e.g., new BF, new TF, and/or new UF may be provided as new second onboarding process data for the particular customer that may be provided as new input data (e.g., new onboarding feature data) into one or more CSIP models (e.g., as new CSIP onboarding feature data) and/or into one or more CSCP models (e.g., as new CSCP onboarding feature data) for potentially adjusting the customized onboarding process currently underway.

Such CSCP and/or CSIP models (e.g., neural networks) running on any suitable processing units (e.g., graphical processing units (“GPUs”) that may be available to SP subsystem 200) provide significant speed improvements in efficiency and accuracy with respect to prediction over other types of algorithms and human-conducted analysis of data, as such models can provide estimates in a few milliseconds or less, thereby improving the functionality of any computing device on which they may be run. Due to such efficiency and accuracy, such models enable a technical solution for enabling dynamic customization of onboarding processes (e.g., availability of or length of a free trial window and/or deferment of any authorization request(s)) using any suitable real-time data (e.g., data made available to the models during the onboarding) that may not be possible without the use of such models, as such models may increase performance of their computing device(s) by requiring less memory, providing faster response times, and/or increased accuracy and/or reliability. Due to the condensed time frame of certain onboarding processes and/or the time within which a decision with respect to a characteristic of certain onboarding processes ought to be made to provide a desirable customer experience (e.g., substantially instantaneously), such models offer the unique ability to provide accurate determinations with the speed necessary to enable accurate decisions for initially customizing onboarding processes and/or dynamically adjusting such customized onboarding processes. Such models enable a data-driven model for customizing an onboarding process as opposed to a pre-defined onboarding process, a dynamically refreshable onboarding process as opposed to a static onboarding process, and/or a utility probability based onboarding process as opposed to a purely rule-based onboarding process.

CM subsystem 300 may be provided by any suitable credential manager that may manage any funding account on behalf of a customer and/or that may provide a customer with any suitable customer transaction credential that may be used to identify to a service provider an associated funding account from which funds may be transferred to an account of the service provider in exchange for any suitable goods and/or services of the service provider. CM subsystem 300 may include a payment network subsystem (e.g., a payment card association or a credit card association) and/or an issuing bank subsystem and/or any other suitable type of subsystem. A specific customer transaction credential that may be used during a service transaction with SP subsystem 200 may be associated with a specific funding account of a particular user with CM subsystem 300 (e.g., accounts for various types of payment cards may include credit cards, debit cards, charge cards, stored-value cards (e.g., transit cards), fleet cards, gift cards, and the like). Such a customer transaction credential may be provisioned on device 100 (e.g., as CM credential information of an applet on a secure credential component (e.g., NFC component, secure element, and/or the like) of device 100) by CM subsystem 300 and may later be used by device 100 as at least a portion of a service transaction order communicated to SP subsystem 200 for funding a transaction between a customer and SP subsystem 200 (e.g., to pay for a good or service of the SP of SP subsystem 200). Alternatively, such a customer transaction credential may be provided to a customer as a physical credential card or any suitable credential information that may be relayed by the customer to an SP (e.g., over the telephone or via manual entry into a web form), which may be used by the SP for funding a service transaction.

SP subsystem 200 may be provided by any suitable service provider that may provide a free trial for any suitable SP product and/or a paid session for any suitable SP product (e.g., a service transaction for providing any suitable goods and/or services) to a customer or another entity or device of the customer's choosing. As just one example, SP subsystem 200 may be provided by Apple Inc. of Cupertino, Calif., which may be a provider of various services to users of device 100 (e.g., the iTunes™ Store for selling/renting media to be played by device 100, the Apple App Store™ for selling/renting applications for use on device 100, the Apple Music™ Service for providing a subscription streaming service, the Apple iCloud™ Service for storing data from device 100 and/or associating multiple user devices and/or multiple user profiles with one another, the Apple Online Store for buying various Apple products online, etc.), and which may also be a provider, manufacturer, and/or developer of device 100 itself (e.g., when device 100 is an iPod™, iPad™, iPhone™, or the like) and/or of an operating system (e.g., device application 103) of device 100. As another example, SP subsystem 200 may be provided by a restaurant or a movie theater or an airline or a car dealership or any other suitable SP entity. The SP that may provide SP subsystem 200 (e.g., Apple Inc.) may be distinct and independent from any CM of any remote CM subsystem 300 (e.g., any funding entity of any remote funding subsystem, any financial institution entity of any remote financial institution subsystem, etc.). For example, the SP that may provide SP subsystem 200 may be distinct and/or independent from any payment network or issuing bank that may furnish and/or manage any credit card or any other customer transaction credential and/or customer payment credential and/or customer funding credential to be used by a customer for funding a service transaction with SP subsystem 200.

Communication of any suitable data between electronic device 100 and CM subsystem 300 may be enabled via any suitable communications set-up 95, which may include any suitable wired communications path, wireless communications path, or combination of two or more wired and/or wireless communications paths using any suitable communications protocol(s) and/or any suitable network and/or cloud architecture(s). Additionally or alternatively, communication of any suitable data between SP subsystem 200 and CM subsystem 300 may be enabled via any suitable communications set-up 95. Additionally or alternatively, communication of any suitable data between electronic device 100 and SP subsystem 200 that may not be made via CM subsystem 300 may be enabled via any suitable communications set-up 95. Communications set-up 95 may be at least partially managed by one or more trusted service managers (“TSMs”). Any suitable circuitry, device, system, or combination of these (e.g., a wired and/or wireless communications infrastructure that may include one or more communications towers, telecommunications servers, or the like) that may be operative to create a communications network may be used to provide at least a portion of communications set-up 95, which may be capable of providing communications using any suitable wired or wireless communications protocol. For example, communications set-up 95 may support Wi-Fi (e.g., an 802.11 protocol), ZigBee (e.g., an 802.15.4 protocol), WiDi™, Ethernet, Bluetooth™, BLE, high frequency systems (e.g., 900 MHz, 2.4 GHz, and 5.6 GHz communication systems), infrared, TCP/IP, SCTP, DHCP, HTTP, BitTorrent™, FTP, RTP, RTSP, RTCP, RAOP, RDTP, UDP, SSH, WDS-bridging, any communications protocol that may be used by wireless and cellular telephones and personal e-mail devices (e.g., GSM, GSM plus EDGE, CDMA, OFDMA, HSPA, multi-band, etc.), any communications protocol that may be used by a low power Wireless Personal Area Network (“6LoWPAN”) module, any other communications protocol, or any combination thereof.

### Description of FIG. 2

As shown in FIG. 2, for example, electronic device 100 may be any suitable electronic device that may interface with SP subsystem 200 in any suitable manner, such as via any suitable online resource, for enabling a customer user to attempt a new service sign-up for initiating an onboarding process with the SP for a service to be purchased and/or that may interface with CM subsystem 300 in any suitable manner, such as via any suitable online resource, for enabling a customer user to review previous transactions made with a transaction credential of the CM. For example, electronic device 100 may include, but is not limited to, a media player (e.g., an iPod™ available by Apple Inc. of Cupertino, Calif.), video player, still image player, game player, other media player, music recorder, movie or video camera or recorder, still camera, other media recorder, radio, medical equipment, domestic appliance, transportation vehicle instrument, musical instrument, calculator, cellular telephone (e.g., an iPhone™ available by Apple Inc.), other wireless communication device, personal digital assistant, remote control, pager, computer (e.g., a desktop, laptop, tablet (e.g., an iPad™ available by Apple Inc.), server, etc.), monitor, television, stereo equipment, set up box, set-top box, boom box, modem, router, printer, watch, biometric monitor, or any combination thereof. In some embodiments, electronic device 100 may perform a single function (e.g., a device dedicated to interfacing with remote subsystems via online resources) and, in other embodiments, electronic device 100 may perform multiple functions (e.g., a device that interfaces with remote subsystems via online resources and that manages a media library, plays music, and receives and transmits telephone calls). Electronic device 100 may be any portable, mobile, hand-held, or miniature electronic device that may be configured to interface with SP subsystem 200 and/or CM subsystem 300 wherever a user travels. Some miniature electronic devices may have a form factor that is smaller than that of hand-held electronic devices, such as an iPod™. Illustrative miniature electronic devices can be integrated into various objects that may include, but are not limited to, watches (e.g., an Apple Watch™ available by Apple Inc.), rings, necklaces, belts, accessories for belts, headsets, accessories for shoes, virtual reality devices, glasses, other wearable electronics, accessories for sporting equipment, accessories for fitness equipment, key chains, or any combination thereof. Alternatively, electronic device 100 may not be portable at all, but may instead be generally stationary.

As shown in FIG. 2, for example, electronic device 100 may include processing circuitry 102, memory 104, power supply circuitry 106, input component circuitry 108, output component circuitry 110, sensor circuitry 112, and communications circuitry 114. Electronic device 100 may also include a bus 115 that may provide one or more wired or wireless communication links or paths for transferring data and/or power to, from, or between various other components of device 100. In some embodiments, one or more components of electronic device 100 may be combined or omitted. Moreover, electronic device 100 may include any other suitable components not combined or included in FIG. 2 and/or several instances of the components shown in FIG. 2. For the sake of simplicity, only one of each of the components is shown in FIG. 2.

Memory 104 may include one or more storage mediums, including, for example, a hard-drive, flash memory, permanent memory such as read-only memory (“ROM”), semi-permanent memory such as random access memory (“RAM”), any other suitable type of storage component, or any combination thereof. Memory 104 may include cache memory, which may be one or more different types of memory used for temporarily storing data for electronic device applications. Memory 104 may be fixedly embedded within electronic device 100 or may be incorporated onto one or more suitable types of cards that may be repeatedly inserted into and removed from electronic device 100 (e.g., a subscriber identity module (“SIM”) card or secure digital (“SD”) memory card). Memory 104 may store media data (e.g., music and image files), software (e.g., for implementing functions on device 100), firmware, media information (e.g., media content and/or associated metadata), preference information (e.g., media playback preferences), lifestyle information (e.g., food preferences), exercise information (e.g., information obtained by exercise monitoring equipment or any suitable sensor circuitry), transaction information (e.g., information such as credit card information or other transaction credential information), wireless connection information (e.g., information that may enable device 100 to establish a wireless connection), subscription information (e.g., information that keeps track of podcasts or television shows or other media a user subscribes to), contact information (e.g., telephone numbers and e-mail addresses), calendar information, pass information (e.g., transportation boarding passes, event tickets, coupons, store cards or other transaction credentials (e.g., financial payment cards), etc.), any suitable model data of device 100 (e.g., as may be stored in any suitable device model 105 of memory assembly 104 (e.g., any portion or all of one, some, or each model of SP subsystem 200 or otherwise as may be described herein)), any other suitable data, or any combination thereof.

Power supply circuitry 106 can include any suitable circuitry for receiving and/or generating power, and for providing such power to one or more of the other components of electronic device 100. For example, power supply circuitry 106 can be coupled to a power grid (e.g., when device 100 is not acting as a portable device or when a battery of the device is being charged at an electrical outlet with power generated by an electrical power plant). As another example, power supply circuitry 106 can be configured to generate power from a natural source (e.g., solar power using solar cells). As another example, power supply circuitry 106 can include one or more batteries for providing power (e.g., when device 100 is acting as a portable device). For example, power supply circuitry 106 can include one or more of a battery (e.g., a gel, nickel metal hydride, nickel cadmium, nickel hydrogen, lead acid, or lithium-ion battery), an uninterruptible or continuous power supply (“UPS” or “CPS”), and circuitry for processing power received from a power generation source (e.g., power generated by an electrical power plant and delivered to the user via an electrical socket or otherwise).

One or more input components 108 may be provided to permit a user to interact or interface with device 100. For example, input component circuitry 108 can take a variety of forms, including, but not limited to, a touch pad, dial, click wheel, scroll wheel, touch screen, one or more buttons (e.g., a keyboard), mouse, joy stick, track ball, microphone, still image camera, video camera, scanner (e.g., a bar code scanner or any other suitable scanner that may obtain product identifying information from a code, such as a bar code, or the like), proximity sensor, light detector, biometric sensor (e.g., a fingerprint reader or other feature recognition sensor, which may operate in conjunction with a feature-processing application that may be accessible to electronic device 100 for authenticating a user), line-in connector for data and/or power, and combinations thereof. Each input component 108 can be configured to provide one or more dedicated control functions for making selections or issuing commands associated with operating device 100.

Electronic device 100 may also include one or more output components 110 that may present information (e.g., graphical, audible, and/or tactile information) to a user of device 100. For example, output component circuitry 110 of electronic device 100 may take various forms, including, but not limited to, audio speakers, headphones, line-out connectors for data and/or power, visual displays, infrared ports, tactile/haptic outputs (e.g., rumblers, vibrators, etc.), and combinations thereof. As a particular example, electronic device 100 may include a display output component as output component 110, where such a display output component may include any suitable type of display or interface for presenting visual data to a user. A display output component may include a display embedded in device 100 or coupled to device 100 (e.g., a removable display). A display output component may include display driver circuitry, circuitry for driving display drivers, or both, and such a display output component can be operative to display content (e.g., media playback information, application screens for applications implemented on electronic device 100, information regarding ongoing communications operations, information regarding incoming communications requests, device operation screens, etc.) that may be under the direction of processor 102.

It should be noted that one or more input components and one or more output components may sometimes be referred to collectively herein as an input/output (“I/O”) component or I/O circuitry or I/O interface (e.g., input component 108 and output component 110 as I/O component or I/O interface 109). For example, input component 108 and output component 110 may sometimes be a single I/O component 109, such as a touch screen, that may receive input information through a user's touch (e.g., multi-touch) of a display screen and that may also provide visual information to a user via that same display screen.

Sensor circuitry 112 may include any suitable sensor or any suitable combination of sensors operative to detect movements of electronic device 100 and/or any other characteristics of device 100 or its environment (e.g., physical activity or other characteristics of a user of device 100). For example, sensor circuitry 112 may include any suitable sensor(s), including, but not limited to, one or more of a GPS sensor, accelerometer, directional sensor (e.g., compass), gyroscope, motion sensor, pedometer, passive infrared sensor, ultrasonic sensor, microwave sensor, a tomographic motion detector, a camera, a biometric sensor, a light sensor, a timer, or the like. In some examples, a biometric sensor may include, but is not limited to, one or more health-related optical sensors, capacitive sensors, thermal sensors, electric field (“eField”) sensors, and/or ultrasound sensors, such as photoplethysmogram (“PPG”) sensors, electrocardiography (“ECG”) sensors, galvanic skin response (“GSR”) sensors, posture sensors, stress sensors, photoplethysmogram sensors, and/or the like. While specific examples are provided, it should be appreciated that other sensors can be used and other combinations of sensors can be combined into a single device. In some examples, a GPS sensor or any other suitable location detection component(s) of device 100 can be used to determine a user's location and movement, as well as a displacement of the user's motion.

Communications circuitry 114 may be provided to allow device 100 to communicate with one or more other electronic devices or servers using any suitable communications protocol (e.g., with CM subsystem 300 and/or with SP subsystem 200 using communications set-up 95). For example, communications circuitry 114 may support Wi-Fi™ (e.g., an 802.11 protocol), ZigBee™ (e.g., an 802.15.4 protocol), WiDi™, Ethernet, Bluetooth™, Bluetooth™ Low Energy (“BLE”), high frequency systems (e.g., 900 MHz, 2.4 GHz, and 5.6 GHz communication systems), infrared, transmission control protocol/internet protocol (“TCP/IP”) (e.g., any of the protocols used in each of the TCP/IP layers), Stream Control Transmission Protocol (“SCTP”), Dynamic Host Configuration Protocol (“DHCP”), hypertext transfer protocol (“HTTP”), BitTorrent™, file transfer protocol (“FTP”), real-time transport protocol (“RIP”), real-time streaming protocol (“RTSP”), real-time control protocol (“RTCP”), Remote Audio Output Protocol (“RAOP”), Real Data Transport Protocol™ (“RDTP”), User Datagram Protocol (“UDP”), secure shell protocol (“SSH”), wireless distribution system (“WDS”) bridging, any communications protocol that may be used by wireless and cellular telephones and personal e-mail devices (e.g., Global System for Mobile Communications (“GSM”), GSM plus Enhanced Data rates for GSM Evolution (“EDGE”), Code Division Multiple Access (“CDMA”), Orthogonal Frequency-Division Multiple Access (“OFDMA”), high speed packet access (“HSPA”), multi-band, etc.), any communications protocol that may be used by a low power Wireless Personal Area Network (“6LoWPAN”) module, Near Field Communication (“NFC”), any other communications protocol, or any combination thereof. Communications circuitry 114 may also include or be electrically coupled to any suitable transceiver circuitry that can enable device 100 to be communicatively coupled to another device (e.g., a host computer or an accessory device) and communicate with that other device wirelessly, or via a wired connection (e.g., using a connector port). Communications circuitry 114 may be configured to determine a geographical position of electronic device 100. For example, communications circuitry 114 may utilize the global positioning system (“GPS”) or a regional or site-wide positioning system that may use cell tower positioning technology or Wi-Fi™ technology.

Processing circuitry 102 of electronic device 100 may include any processing circuitry that may be operative to control the operations and performance of one or more components of electronic device 100. For example, processor 102 may receive input signals from any input component 108 and/or sensor circuitry 112 and/or communications circuitry 114 and/or drive output signals through any output component 110 and/or communications circuitry 114. As shown in FIG. 2, processor 102 may be used to run at least one application 103. Application 103 may include, but is not limited to, one or more operating system applications, firmware applications, software applications, third party applications (e.g., applications managed by the SP of SP subsystem 200, the CM of CM subsystem 300, and/or the like), online resource applications, algorithmic modules, media analysis applications, media playback applications, media editing applications, communications applications, pass applications, calendar applications, social media applications, state determination applications, biometric feature-processing applications, activity monitoring applications, activity motivating applications, and/or any other suitable applications. For example, processor 102 may load application 103 as a user interface program to determine how instructions or data received via an input component 108 and/or any other component of device 100 may manipulate the one or more ways in which information may be stored and/or provided to the user via an output component 110 and/or any other component of device 100. Any application 103 may be accessed by any processing circuitry 102 from any suitable source, such as from memory 104 (e.g., via bus 115) and/or from another device or server (e.g., from CM subsystem 300 and/or from SP subsystem 200 (e.g., via an active Internet connection (e.g., via communications circuitry 114))). For example, application 103 may be any suitable internet browsing application (e.g., for interacting with a website provided by CM subsystem 300 and/or by SP subsystem 200 for enabling device 100 to interact with an online service of CM subsystem 300 and/or SP subsystem 200), any suitable CM application (e.g., a web application or a native application that may be at least partially produced by CM subsystem 300 for enabling device 100 to interact with an online service of CM subsystem 300), any suitable SP application (e.g., a web application or a native application that may be at least partially produced by SP subsystem 200 for enabling device 100 to interact with an online service of SP subsystem 200), or any other suitable applications. As one example, an application 103 may provide a user with the ability to interact with a service or platform of CM subsystem 300, where such an application 103 may be a third party application that may be running on device 100 (e.g., an application associated with CM subsystem 300 that may be loaded on device 100 from CM subsystem 300 or via an application market (e.g., from SP subsystem 200 if a media market SP) and/or that may be accessed via an internet application or web browser running on device 100 (e.g., processor 112) that may be pointed to a uniform resource locator (“URL”) whose target or web resource may be managed by CM subsystem 300 (e.g., running on a server of CM subsystem 300) or any other remote subsystem). Therefore, application 103 may be configured to provide a CM online resource, such as a website or native online application, for presentation of a CM interface to a user on device 100. As another example, an application 103 may provide a user with the ability to interact with a service or platform of SP subsystem 200, where such an application 103 may be a third party application that may be running on device 100 (e.g., an application associated with SP subsystem 200 that may be loaded on device 100 from SP subsystem 200 or via an application market (e.g., from SP subsystem 200 if a media market SP) and/or that may be accessed via an internet application or web browser running on device 100 (e.g., processor 112) that may be pointed to a uniform resource locator (“URL”) whose target or web resource may be managed by SP subsystem 200 (e.g., running on a server of SP subsystem 200) or any other remote subsystem). Therefore, application 103 may be configured to provide an SP online resource, such as a website or native online application, for presentation of a SP interface to a user on device 100. In a particular example, as shown in FIG. 2, processor 102 may be used to run a first application 103 that may be an operating system application and a second application 103a that may be a third party application or any other suitable online resource (e.g., an application associated with a service provider of SP subsystem 200 (e.g., a media store, an app store, etc.) or an application associated with a credential manager of CM subsystem 300 (e.g., credential manager app, etc.)). Moreover, processor 102 may have access to device identification information 119, which may be utilized to provide identification of device 100 (e.g., identification of the particular device 100 and/or identification of the type of device 100 (e.g., make and/or model and/or the like) to a remote subsystem (e.g., a unique device identification to SP subsystem 200 and/or to CM subsystem 300)) (e.g., such that certain device information may be securely and confidentially shared with one or more of subsystems 200 and 300 (e.g., the location of device 100 and/or the usage of an SP media application on device 100, etc.)). Processor 102 may include a single processor or multiple processors. For example, processor 102 may include at least one “general purpose” microprocessor, a combination of general and special purpose microprocessors, instruction set processors, graphics processors, video processors, communications processors, motion processors, biometric processors, application processors, and/or related chips sets, and/or special purpose microprocessors. Processor 102 also may include on board memory for caching purposes.

Although not shown, device 100 may include any suitable secure credential component (e.g., NFC component, secure element, and/or the like) that may include or otherwise be configured to provide a tamper-resistant platform (e.g., as a single-chip or multiple-chip secure microcontroller) that may be capable of securely hosting applications and their confidential and cryptographic data in accordance with rules and security requirements that may be set forth by a set of well-identified trusted authorities (e.g., an authority of SP subsystem 200 and/or of CM subsystem 300 and/or of an industry standard, such as GlobalPlatform). Any suitable customer transaction credential information, such as CM credential information, may be stored in an applet on such a secure credential component of device 100 and may be configured to provide customer transaction credential data for use in any suitable service transaction order with a remote entity subsystem, such as SP subsystem 200. For example, the customer transaction credential data may provide an actual value source and/or may provide sufficient detail for identifying a funding account of CM subsystem 300 that may be used to as a value source, and the value source may be used to at least partially fund a service transaction between electronic device 100 and SP subsystem 200 for any suitable service provider service (e.g., any suitable good or service that may be provided on behalf of SP subsystem 200 for the benefit of a user of electronic device 100).

Electronic device 100 may also be provided with a housing 101 that may at least partially enclose one or more of the components of device 100 for protection from debris and other degrading forces external to device 100. In some embodiments, one or more of the components may be provided within its own housing (e.g., input component 108 may be an independent keyboard or mouse within its own housing that may wirelessly or through a wire communicate with processor 102, which may be provided within its own housing).

Although not shown, SP subsystem 200 may also include a processor component that may be the same as or similar to processor component 102 of electronic device 100, a communications component that may be the same as or similar to communications component 114 of electronic device 100, an I/O interface that may be the same as or similar to I/O interface 109 of electronic device 100, a bus that may be the same as or similar to bus 115 of electronic device 100, a memory component that may be the same as or similar to memory 104 of electronic device 100, and/or a power supply component that may be the same as or similar to power supply 106 of electronic device 100.

Although not shown, CM subsystem 300 may also include a processor component that may be the same as or similar to processor component 102 of electronic device 100, a communications component that may be the same as or similar to communications component 114 of electronic device 100, an I/O interface that may be the same as or similar to I/O interface 109 of electronic device 100, a bus that may be the same as or similar to bus 115 of electronic device 100, a memory component that may be the same as or similar to memory 104 of electronic device 100, and/or a power supply component that may be the same as or similar to power supply 106 of electronic device 100.

### Description of FIG. 3 and FIGS. 3A-3J

As shown in FIG. 3, one specific example of electronic device 100 may be an electronic device, such as an iPhone™, where housing 101 may allow access to various input components 108a-108i, various output components 110a-110c, and various I/O components 109a-109c through which device 100 and a user and/or an ambient environment may interface with each other. Input component 108a may include a button that, when pressed, may cause a “home” screen or menu of a currently running application to be displayed by device 100. Input component 108b may be a button for toggling electronic device 100 between a sleep mode and a wake mode or between any other suitable modes. Input component 108c may include a two-position slider that may disable one or more output components 112 in certain modes of electronic device 100. Input components 108d and 108e may include buttons for increasing and decreasing the volume output or any other characteristic output of an output component 110 of electronic device 100. Each one of input components 108a-108e may be a mechanical input component, such as a button supported by a dome switch, a sliding switch, a control pad, a key, a knob, a scroll wheel, or any other suitable form.

An output component 110a may be a display that can be used to display a visual or graphic user interface (“GUI”) 180, which may allow a user to interact with electronic device 100. A screen 190 of GUI 180 may include various layers, windows, screens, templates, elements, menus, and/or other components of a currently running application (e.g., application 103) that may be displayed in all or some of the areas of display output component 110a. One or more of user input components 108a-108i may be used to navigate through GUI 180. For example, one user input component 108 may include a scroll wheel that may allow a user to select one or more graphical elements or icons 182 of GUI 180. Icons 182 may also be selected via a touch screen I/O component 109a that may include display output component 110a and an associated touch input component 108f. Such a touch screen I/O component 109a may employ any suitable type of touch screen input technology, such as, but not limited to, resistive, capacitive, infrared, surface acoustic wave, electromagnetic, or near field imaging. Furthermore, touch screen I/O component 109a may employ single point or multi-point (e.g., multi-touch) input sensing.

Icons 182 may represent various applications, layers, windows, screens, templates, elements, and/or other components that may be displayed in some or all of the areas of display component 110a upon selection by the user. Furthermore, selection of a specific icon 182 may lead to a hierarchical navigation process. For example, selection of a specific icon 182 may lead from screen 190 of FIG. 3 to a new screen of GUI 180 that may include one or more additional icons or other GUI elements of the same application or of a new application associated with that icon 182. Textual indicators 181 may be displayed on or near each icon 182 to facilitate user interpretation of each graphical element icon 182. It is to be appreciated that GUI 180 may include various components arranged in hierarchical and/or non-hierarchical structures. When a specific icon 182 is selected, device 100 may be configured to open a new application associated with that icon 182 and display a corresponding screen of GUI 180 associated with that application. As an example, when the specific icon labeled with a “Calendar” textual indicator is selected, device 100 may launch or otherwise access a specific calendar or reminder application and may display screens of a specific user interface that may include one or more tools or features for interacting with one or more events or other reminders that may be time-sensitive in a specific manner. As another example, when the specific icon labeled with a “Credential Manager” textual indicator is selected, device 100 may launch or otherwise access a specific CM application (e.g., CM online resource) and may display screens of a specific user interface that may include one or more tools or features for interacting with CM subsystem 300 in a specific manner. As another example, when the specific icon labeled with a “Wallet” textual indicator is selected, device 100 may launch or otherwise access a specific pass or wallet application and may display screens of a specific user interface that may include one or more tools or features for interacting with one or more passes or other credentials (e.g., payment credentials of an NFC and/or secure element component of device 100) in a specific manner. As another example, when the specific icon labeled with a “Music Service” or “MS” (or other suitable service) textual indicator 181 is selected, device 100 may launch or otherwise access a specific music (or other suitable service) subscription application and may display screens of a specific user interface that may include one or more tools or features for interacting with such a music (or other suitable service) application in a specific manner (see, e.g., FIGS. 3A-3J for specific examples of such displays of GUI 180 during use of any suitable subscription application (e.g., a subscription application 103a) that may be used by a device user for subscribing to a service or for accessing any other suitable SP product). For each application, screens may be displayed on display output component 110a and may include various user interface elements. Additionally or alternatively, for each application, various other types of non-visual information may be provided to a user via various other output components 110 of device 100.

Electronic device 100 also may include various other I/O components 109 that may allow for communication between device 100 and other devices, such as a connection port 109b that may be configured for transmitting and receiving data files, such as media files or customer order files, and/or any suitable information (e.g., audio signals) from a remote data source and/or power from an external power source. For example, I/O component 109b may be any suitable port (e.g., a Lightning™ connector or a 30-pin dock connector available by Apple Inc.). I/O component 109c may be a connection slot for receiving a SIM card or any other type of removable component. Electronic device 100 may also include at least one audio input component 110g, such as a microphone, and at least one audio output component 110b, such as an audio speaker. Electronic device 100 may also include at least one tactile output component 110c (e.g., a rumbler, vibrator, haptic and/or taptic component, etc.), a camera and/or scanner input component 108h (e.g., a video or still camera, and/or a bar code scanner or any other suitable scanner that may obtain product identifying information from a code, such as a bar code, or the like), and a biometric input component 108i (e.g., a fingerprint reader or other feature recognition sensor, which may operate in conjunction with a feature-processing application that may be accessible to electronic device 100 for authenticating a user).

### Description of FIGS. 4 and 5

Referring now to FIG. 4, FIG. 4 shows further details with respect to particular embodiments of SP subsystem 200 of system 1. As shown in FIG. 4, SP subsystem 200 may be a secure platform system and may include a secure mobile platform (“SMP”) broker component 240, an SMP trusted services manager (“TSM”) component 250, an SMP crypto services component 260, an identity management system (“IDMS”) component 270, a fraud system component 280, a hardware security module (“HSM”) component 290, a store component 265, and/or one or more servers 210. One, some, or all components of SP subsystem 200 may be implemented using one or more processor components, which may be the same as or similar to processor circuitry 102 of device 100, one or more memory components, which may be the same as or similar to memory 104 of device 100, and/or one or more communications components, which may be the same as or similar to communications circuitry 114 of device 100. Any suitable communication protocol or combination of communication protocols may be used by SP subsystem 200 to communicate data amongst the various components of SP subsystem 200 (e.g., via at least one communications path 295 of FIG. 4) and/or to communicate data between SP subsystem 200 and other components of system 1 (e.g., CM subsystem 300 and/or electronic device 100). One, some, or all components of SP subsystem 200 may be managed by, owned by, at least partially controlled by, and/or otherwise provided by or for a single SP (e.g., Apple Inc.) that may be distinct and independent from any CM subsystem 300. The components of SP subsystem 200 may interact with each other and collectively with any suitable CM subsystem 300 and/or electronic device 100 for facilitating one or more service onboarding processes and/or for training, inferring, managing, or otherwise using one or more CSIP models and/or one or more CSCP models and/or one or more free trial window length determination calculation subprocesses for customizing one or more service onboarding processes for one or more customers.

SMP broker component 240 of SP subsystem 200 may be configured to manage customer authentication with an SP customer account of SP subsystem 200 and/or to manage CM validation with a CM subsystem account of SP subsystem 200. SMP broker component 240 may be a primary end point that may control certain interface elements (e.g., elements of a GUI 180) on device 100. A CM application of CM subsystem 300 may be configured to call specific application programming interfaces (“APIs”) and SMP broker 240 may be configured to process requests of those APIs and respond with data that may derive a portion of a user interface that may be presented by CM subsystem 300 (e.g., to device 100) and/or respond with application protocol data units (“APDUs”) that may communicate with CM subsystem 300. Such APDUs may be received by SP subsystem 200 from CM subsystem 300 via a trusted services manager (“TSM”) of system 1 (e.g., a TSM of a communication path between SP subsystem 200 and CM subsystem 300). In some particular embodiments, SMP TSM component 250 of SP subsystem 200 may be configured to provide Global Platform-based services or any other suitable services that may be used to carry out credential provisioning operations on device 100 from CM subsystem 300. GlobalPlatform, or any other suitable secure channel protocol, may enable SMP TSM component 250 to properly communicate and/or provision sensitive account data between a secure element of device 100 and a TSM for secure data communication between SP subsystem 200 and a remote subsystem.

SMP TSM component 250 may be configured to use HSM component 290 to protect keys and generate new keys. SMP crypto services component 260 of SP subsystem 200 may be configured to provide key management and cryptography operations that may be provided for user authentication and/or confidential data transmission between various components of system 1 (e.g., between SP subsystem 200 and CM subsystem 300 and/or between SP subsystem 200 and device 100 and/or between different components of SP subsystem 200). SMP crypto services component 260 may utilize HSM component 290 for secure key storage and/or opaque cryptographic operations. A payment crypto service of SMP crypto services component 260 may be configured to interact with IDMS component 270 to retrieve information associated with on-file credit cards or other types of customer transaction credentials associated with user accounts of the SP (e.g., an Apple iCloud™ account). Such a payment crypto service may be configured to be the only component of SP subsystem 200 that may have clear text (e.g., non-hashed) information describing customer transaction credentials (e.g., credit card numbers) of its user accounts in memory. Fraud system component 280 of SP subsystem 200 may be configured to run an SP fraud check on a customer transaction credential based on data known to the SP about the transaction credential and/or the customer (e.g., based on data (e.g., customer transaction credential information) associated with a customer account with the SP and/or any other suitable data that may be under the control of the SP and/or any other suitable data that may not be under the control of a remote subsystem). Fraud system component 280 may be configured to determine an SP fraud score for the credential based on various factors or thresholds. Additionally or alternatively, SP subsystem 200 may include store 265, which may be a provider of various services to users of device 100 (e.g., the iTunes™ Store for selling/renting media to be played by device 100, the Apple App Store™ for selling/renting applications for use on device 100, the Apple iCloud™ Service for storing data from device 100 and/or associating multiple user devices and/or multiple user profiles with one another, the Apple Online Store for buying various Apple products online, the Apple Music™ Service for enabling subscriptions of various streaming services, etc.). As just one example, store 265 may be configured to manage and provide an application 103 and/or application 103a to device 100, where the application may be any suitable application, such as a CM application (e.g., a banking application), an SP application (e.g., a music streaming (or other suitable) service application), an e-mail application, a text messaging application, an internet application, a credential management application, or any other suitable communication application, and/or to provide any suitable SP product to a customer (e.g., a media file to memory 104 of customer device 100, etc.).

Server 210 may be any suitable server that may be operative to handle any suitable services or functionalities of SP subsystem 200. In other embodiments, at least a portion or the entirety of server 210 may be an independent subsystem distinct from SP subsystem 200 (e.g., as a third party subsystem of a third party that may be distinct from the SP of SP subsystem 200 or as another subsystem provided by the SP of SP subsystem 200 that may be distinct from SP subsystem 200). As shown in FIG. 5, server 210 may be a model management server that may be operative to train, infer, manage, or otherwise use one or more models (e.g., one or more CSIP models and/or one or more CSCP models) for customizing the use of one or more onboarding processes for one or more customers of SP subsystem 200 for one or more services of SP subsystem 200 (in some embodiments, server 210 may be used to communicate one or more models for use on a user electronic device (e.g., device 100) for customizing the use of one or more onboarding processes for one or more customers of SP subsystem 200 for one or more services of SP subsystem 200). For example, at least one model, such as one or more models 205, may be developed and/or generated for use in determining an appropriate probability of successful customer payment for a particular service being onboarded and/or for use in determining an appropriate probability of successful customer intention for retention for the particular service being onboarded and/or for use in determining an appropriate customized trial length window for a free trial for the particular service being onboarded and/or for otherwise customizing any suitable aspect of customer onboarding for a service. For example, any or all onboarding data 211 available to system 1 (e.g., data indicative of any or all characteristics of any or all transactions or customer onboardings previously completed and/or attempted by SP subsystem 200 or otherwise for any customers or subset of customers (e.g., account history, purchase history, authorization history, billing history, subscription history, onboarding history, and/or the like available to SP subsystem 200 and/or CM subsystem 300 and/or one or more customer devices 100 and/or any other suitable subsystems or data sources accessible by server 210)) may be collected at a data storage (e.g., file system and/or database) 212, and a feature generator 214 may be operative to selectively pull some or all such onboarding data 211 from data storage 212 as batch job data 215 into a batch job data storage (e.g., file system and/or database) 216, where batch job data 215 may be all onboarding data of data 211 that was generated within the last 30 days (e.g., onboarding data associated with onboardings initiated within the last 30 days) or any other suitable timeframe and/or all onboarding data with any other suitable commonality. As shown, for example, data 211 and/or data 215 may include various feature onboarding data, including, but not limited to, any suitable I/F data, any suitable BF data, any suitable TF data, any suitable TL data, and/or certain specific types of data that may be used for training a CSIP model and/or a CSCP model and/or any other suitable type of model for any other suitable purpose, including but not limited to, “buys_last_x_days” (e.g., number of purchases attempted within last X days by a particular customer associated with a particular onboarding data set), “amt_last_x_days” (e.g., total value amount and/or transaction count of all transactions attempted within last X days by a particular customer associated with a particular onboarding data set), “sess_last_x_days” (e.g., total number of payment sessions activated within last X days by a particular customer associated with a particular onboarding data set), average total value amount per day of all transactions attempted over last X days by a particular customer associated with a particular onboarding data set, average minimum value amount per day of all transactions attempted over last X days by a particular customer associated with a particular onboarding data set, average maximum value amount per day of all transactions attempted over last X days by a particular customer associated with a particular onboarding data set, average number of transactions per day attempted over last X days by a particular customer associated with a particular onboarding data set, minimum interval between transactions attempted over last X days by a particular customer associated with a particular onboarding data set, maximum interval between transactions attempted over last X days by a particular customer associated with a particular onboarding data set, number of billing accounts used over last X days by a particular customer associated with a particular onboarding data set, number of successful authorizations over last X days for a particular customer associated with a particular onboarding data set, ratio of successful authorizations to all authorization requests over last X days for a particular customer associated with a particular onboarding data set, number of in-app purchases (or any particular product or service type of purchase) over last X days by a particular customer associated with a particular onboarding data set, list of genres of products or content types purchased over last X days by a particular customer associated with a particular onboarding data set, “layers_to_fraudster” (e.g., closeness of customer to another user that has been identified as a fraudster (e.g., as may be determined by a user graph of users connected by one or more shared properties, such as social network relations, geographical distances, internet protocol similarities, SP products of interest/attempted to be purchased similarities, etc.), which may be indicative of a level of suspiciousness attributed to the customer), and/or the like. A model builder 218 may be operative to receive some or all of batch job data 215 from batch job database 216 (or some or all of data 211 from database 212 when generator 214 and/or database 216 may not be used) and to use such data to build (e.g., train) one or more models 205 (e.g., one or more batch job models 217), such as one or more regression models, boosted tree models, neural network models, and/or any other suitable types of models, one or more of which may be trained as a particular type of model (e.g., a CSIP model and/or a CSCP model, etc.).

Some or all models generated or otherwise trained or built by model builder 218 may be collected by a model repository 232, while a best model identifier 234 may be operative to identify the best performing model(s) of model repository 232 using any suitable techniques (e.g., model identifier 234 may identify a best performing model for each one of the various types of models available to system 1 at a particular moment (e.g., a best performing CSIP model, a best performing CSCP model, etc.), each of which may be the same or different type of machine learning model). Then, when one or more particular types of model is to be used to customize an onboarding for a particular customer for a particular service, a model request server 236 may be operative to receive from any suitable source (e.g., any suitable client source for server 210 (e.g., store 265)) a request 239 for such model(s) that may include model request data 239d (e.g., any suitable onboarding data associated with a particular customer and/or a particular onboarding of that customer for a particular service, including, but not limited to, any suitable UF data, BF data, TF data, TL data, a “dsid” (e.g., a unique customer identifier for the particular customer and/or a customer score indicative of some trustworthiness or fraud score or otherwise that may be associated with the customer), a “store_front_id” (e.g., an identifier of the particular store that received the transaction purchase attempt from the customer (e.g., a particular app store, a particular music subscription service, etc.)), a “buy_amount” (e.g., a value amount of the SP product(s) to be purchased (e.g., eventually) in the onboarding), “buys_last_x_hours” (e.g., number of purchases attempted or authorized for the particular customer during the last X hours), “card_type” (e.g., type of transaction credential being used or otherwise determined to be available for use in the onboarding attempt), “flow_step” (e.g., relative operation within a customization flow at which request 239 was generated (e.g., which operation (e.g., operation 610, 612, and/or 628) and/or the like of process 600 of FIG. 6 initiated the request and from which other operation did process 600 arrive at that operation, etc.)), and/or the like (e.g., any suitable type/feature of onboarding data that may also be represented by data 211, 215, 221, 225, and/or the like)).

In response to receiving such a request 239, model request server 236 may be operative to use some or all of model request data 239d as input data to one or more of the models available to model request server 236 (e.g., one or more of the best CSIP models and/or one or more of the best CSCP models of best model identifier 234) in order to receive appropriate model output data 205d (e.g., any suitable model output data that may be used to customize an onboarding experience for the particular customer, including, but not limited to, one or more CSIP P_{STAY} scores for the particular customer's onboarding as may be determined by one or more best performing CSIP models available to model request server 236 using at least some onboarding data of model request data 239d as model input data (e.g., as may be used by operation 612 of process 600), one or more CSCP P_{PAY} scores for the particular customer's onboarding as may be determined by one or more best performing CSCP models available to model request server 236 using at least some onboarding data of model request data 239d as model input data (e.g., as may be used by operation 610 and/or operation 628 of process 600), and/or the like).

Any or all of such model output data 205d that may be received by model request server 236 for a particular request 239 may be provided as at least a portion of any suitable model response data 237d for a model response 237 that may be returned by server 210 to any suitable target (e.g., the client source (e.g., store 265) that may have provided request 239). As shown, in addition to any suitable model output data 205d, model response data 237d may include any suitable additional model response data that may help facilitate customization and/or utilization of customer onboarding for a particular service, including, but not limited to, a “dsid” (e.g., the unique customer identifier for the particular customer and/or a customer score indicative of some trustworthiness or fraud score or otherwise that may be associated with the customer (e.g., the same identifier as in request 239, which may facilitate linking request 239 and response 237)), a “timestamp” (e.g., any suitable timestamp indicative of the time at which all or any suitable portion of response data 237d may have been generated and/or the potential time with which a particular CSIP and/or CSCP score is associated), a “model version” (e.g., any suitable data that may be indicative of a particular model of server 210 that may have been used to generate at least a portion of data 205d and/or of a type of such a model and/or the like, which may be used for diagnostic purposes or any other suitable purposes, where such optional data may be exposed to the client and may be useful, for example, when the client would like to determine how and/or when the model output evolved, where an A/B test or experiment or otherwise might be conducted based on such data by the client or otherwise), and/or the like.

As also shown in FIG. 5, server 210 may also include a streaming job set of databases and/or other modules that may be operative to identify certain features/inputs of at least one model that may be of particular significance or importance to the effectiveness of that model. For example, one or more models 205 built by model builder 218 (e.g., one or more batch job models 217) or otherwise available to server 210 may be analyzed in any suitable manner by a feature selector 220 to identify one or more features (e.g., inputs) that have a significant impact on the effectiveness of the model being analyzed (e.g., to determine the input(s) of the model that have the most effect on the output(s) of the model). Then those features of importance (e.g., each feature that reaches a particular importance threshold and/or each one of a particular number of features that are the most important to the model) identified by feature selector 220 for a particular model may be utilized by a streaming job feature generator 224. For example, streaming job feature generator 224 may be operative to selectively pull some or all onboarding data 221 from a queue data storage 222 as shortlist or streaming job data 225 into a streaming job data storage (e.g., file system and/or database) 226, where streaming job data 225 may be only the onboarding data of onboarding data 221 indicative of the features identified by feature selector 220. For example, as shown, data 225 may include various feature onboarding data, including, but not limited to, “buys_last_x_days” (e.g., number of purchases attempted within last X days by a particular customer associated with a particular onboarding data set), “amt_last_x_days” (e.g., total value amount and/or transaction count of all transactions attempted within last X days by a particular customer associated with a particular onboarding data set), “layers_to_fraudster”, and/or the like, but not “sess_last_x_days” (e.g., total number of payment sessions activated within last X days by a particular customer associated with a particular onboarding data set), as may be provided by data 215. In some embodiments, data 221 may differ from data 211 in that data 221 may only be onboarding data generated within a recent period of time (e.g., real-time or near real-time data that may be made accessible to server 210), such as onboarding data generated within the last 5 minutes, or within the last 2 hours or any other suitable batch update refresh period that may otherwise collect new data 211. For example, data 211 and data 221 may differ in any one or more suitable ways, including, but not limited to, length of data processing history (e.g., data 211 may be an archived data processed in the past few days to years, while data 221 may be much more recent data), need for (near) real-time data (e.g., data 211 may have much longer latency than data 221), storage location/database (e.g., data 211 may be stored in a file system (e.g., distributed fie system) or onboarding database while data 221 may be stored in a queue platform with data low-latency, such as Apache Kafka), and/or the like. Then, a streaming job model builder 228 may be operative to receive some or all of the models built by batch job model builder 218 (e.g., one or more models 205 (e.g., one or more batch job models 217) via feature selector 220) as well as streaming job data 225 from streaming job database 226 (or some or all of data 221 from database 222 when generator 224 and/or database 226 may not be used) and to use such data to further build (e.g., re-train or further train or refresh) one or more the received models 205 (e.g., one or more batch job models 217) (e.g., as one or more updated or re-trained or refreshed streaming job models 227), and each re-trained or updated model may be provided via model updater 230 to model repository 232.

Therefore, streaming job model builder 228 may be operative to update one or more batch job models using only particular feature types of onboarding data 225 from data 221 of queue database 222, where such updating by builder 228 may be accomplished with limited overhead and/or limited processing in a more efficient manner (e.g., as only a limited set of features of a limited set of onboarding data may be used to retrain one or more models). Thus, modules 220, 222, 224, 226, 228, and/or 230 may be operative to update and/or improve the training of one or more models based on real-time or near-real time data in an efficient manner (e.g., by focusing on only certain features of onboarding data that may be of significant importance to the effectiveness of the model(s) and/or by only using newly generated onboarding data). This may enable a certain type of model, such as a CSIP model and/or a CSCP model, to be re-trained or otherwise refreshed using onboarding data generated or otherwise first made available to server 210 (e.g., via data 221) during an active onboarding for which that refreshed model may then be used to make a determination on an updated characteristic (e.g., an updated probability) for that active onboarding (e.g., at operation 610 and/or 612 and/or 614 and/or 628 of process 600 (e.g., periodically and/or in response to any new relevant onboarding data being received for the particular customer)).

Any suitable API(s) may be used between any two communicating entities of system 1. Store 265 may call an API endpoint with a request 239 to retrieve a response, and the API response to the call may be a response 237 from server 210. Additionally or alternatively, server 210 may call an API endpoint with a request for any suitable data 211 and/or data 332 from any suitable data source, and the API response to the call may be any suitable onboarding data 211 and/or 221 or otherwise from any suitable data source.

Thus, one or more models 205 managed by server 210 may be operative to effectively and efficiently determine an appropriate customized onboarding for a particular customer for a particular service in a particular onboarding situation. For example, such a model or learning engine may include any suitable neural network (e.g., an artificial neural network) that may be initially configured, trained on one or more sets of scored (e.g., successful and/or failed) onboarding data for one or more past onboardings (e.g., individual and/or aggregated onboardings by any customers or particular customer(s)), and then used to predict an appropriate characteristic or probability for use in customizing a particular onboarding for a particular customer for a particular service in a particular onboarding situation.

A neural network or neuronal network or artificial neural network or any other suitable type of model for use in managing one or more models may be hardware-based, software-based, or any combination thereof, such as any suitable model (e.g., an analytical model, a computational model, etc.), which, in some embodiments, may include one or more sets or matrices of weights (e.g., adaptive weights, which may be numerical parameters that may be tuned by one or more learning algorithms or training methods or other suitable processes) and/or may be capable of approximating one or more functions (e.g., non-linear functions or transfer functions) of its inputs. The weights may be connection strengths between neurons of the network, which may be activated during training and/or prediction. A neural network may generally be a system of interconnected neurons that can compute values from inputs and/or that may be capable of machine learning and/or pattern recognition (e.g., due to an adaptive nature). A neural network may use any suitable machine learning techniques to optimize a training process. The neural network may be used to estimate or approximate functions that can depend on a large number of inputs and that may be generally unknown. The neural network may generally be a system of interconnected “neurons” that may exchange messages between each other, where the connections may have numeric weights (e.g., initially configured with initial weight values) that can be tuned based on experience, making the neural network adaptive to inputs and capable of learning (e.g., learning pattern recognition). A suitable optimization or training process may be operative to modify a set of initially configured weights assigned to the output of one, some, or all neurons from the input(s) and/or hidden layer(s). A non-linear transfer function may be used to couple any two portions of any two layers of neurons, including an input layer, one or more hidden layers, and an output (e.g., an input to a hidden layer, a hidden layer to an output, etc.).

Different input neurons of the neural network may be associated with respective different types of features or categories of onboarding data and may be activated by service feature data or onboarding feature data of the respective onboarding feature (e.g., each possible category or feature of BF onboarding data, each possible category or feature of UF onboarding data, each possible category or feature of TF onboarding data, each possible category or feature of TL onboarding data, each possible category or feature of graph based onboarding data, and/or the like may be associated with one or more particular respective input neurons of the neural network and transaction feature data for the particular onboarding feature may be operative to activate the associated input neuron(s)). The weight assigned to the output of each neuron may be initially configured using any suitable determinations that may be made by a custodian or processor of the model (e.g., server 210) based on the data available to that custodian.

The initial configuring of the learning engine or model (e.g., the initial weighting and arranging of neurons of a neural network of the learning engine) may be done using any suitable data accessible to a custodian of the model. For example, a model custodian may be operative to capture any suitable initial background data about a particular customer or all known customers or a subset of all known customers or all known onboardings or a subset of all known onboardings as well as any suitable result or truth for each onboarding (e.g., successful or failed (e.g., with respect to customer intent and/or customer capability)) in any suitable manner from any suitable sources (e.g., SP subsystem 200, one or more CM subsystems 300, one or more customer devices 100, one or more third party subsystems, or the like). Any suitable training methods or algorithms (e.g., learning algorithms) may be used to train the neural network of the learning engine, including, but not limited to, Back Propagation, Resilient Propagation, Genetic Algorithms, Simulated Annealing, Levenberg, Nelder-Meade, and/or the like. Such training methods may be used individually and/or in different combinations to get the best performance from a neural network. A loop (e.g., a receipt and train loop) of receiving onboarding feature data and a result/truth for an onboarding and then training the model using the received onboarding feature data and result/truth may be repeated any suitable number of times for more effectively training the learning engine, where the received onboarding feature data and the received result/truth of different receipt and train loops may be for different customers or for the same customer (e.g., for different onboardings) and/or may be received from the same source or from different sources. The number and/or type(s) of the one or more types of onboarding features for which onboarding feature data may be received for one receipt and train loop may be the same or different in any way(s) than the number and/or type(s) of the one or more onboarding features for which onboarding feature data may be received for a second receipt and train loop.

### Description of FIG. 6

FIG. 6 is a flowchart of an illustrative process 600 for customizing customer onboarding for a service. Process 600 may provide a seamless and efficient user experience for signing-up for and interacting with a service of SP subsystem 200 via customer electronic device 100 with a goal of eventual customer retention on the service through funding of a customer service transaction using a customer transaction credential that may be managed by CM subsystem 300. To facilitate the following discussion regarding the operation of system 1 for carrying out process 600 of FIG. 6, reference is made to various components of system 1 of the schematic diagrams of FIGS. 1, 2, 3, 4, and 5, and to front views of screens 190-190j of FIGS. 3-3J that may be representative of a graphical user interface of device 100 (e.g., a GUI as may be provided by any suitable SP product application (e.g., service application (e.g., subscription service application)) that may be accessible by device 100) during such a process. The operations described may be achieved with a wide variety of graphical elements and visual schemes. Therefore, the embodiments of FIGS. 3-3J are not intended to be limited to the precise user interface conventions adopted herein. Rather, embodiments may include a wide variety of user interface styles.

At an offline operation 602 of process 600, one or more offline components may be prepared by any suitable sub-operations of operation 602, including operations 602a, 602b, and 602c, for example, prior to a new online onboarding using such offline components at various other operations of process 600 (e.g., one, some, or each one of operations 604-638). At operation 602a, as described above, at least one CSIP model (e.g., one or more CSIPM 602am of FIG. 5) may be trained using any number of appropriate combinations of suitable model input features of a historical onboarding attempt as training inputs (e.g., UF data, BF data, IF data, TL data, etc.) and the resulting label of the historical onboarding attempt (e.g., the eventual success or failure of converting the historic onboarding process of the historic onboarding training data set (e.g., success or failure of getting the customer to use the service of the onboarding (e.g., after any free trial period of the onboarding))) as a training output or truth (e.g., failure (e.g., value 0) or success (e.g., value 1)). Such training for a particular CSIP model 602am may be repeated using any suitable number of historic onboarding training data sets, where each historic onboarding training data set used to train a particular CSIP model 602am may be related to one another in any suitable way(s), such as by being data indicative of an onboarding process for a particular service, such that each CSIP model may be for a particular service (e.g., a music subscription service, a cloud storage service, a movie subscription service, etc.). Additionally or alternatively, different CSIP models 602am may be trained using respective different types of historic onboarding training data sets with respect to one or more types of training inputs (e.g., a first CSIP model for a particular service may be trained using historic onboarding training data sets indicative of an onboarding process in which a free trial window of a first length was utilized, a second CSIP model for a particular service may be trained using historic onboarding training data sets indicative of an onboarding process in which a free trial window of a second length different than the first length was utilized, and so on, such that a particular service may have multiple trained CSIP models, each one associated with a respective free trial window length (or length range)).

At operation 602b, as described above, at least one CSCP model (e.g., one or more CSCPM 602bm of FIG. 5) may be trained using any number of appropriate combinations of suitable model input features of a historical onboarding attempt as training inputs (e.g., UF data, BF data, IF data, TL data, etc.) and the resulting label of the historical onboarding attempt (e.g., the eventual success or failure of collecting funds from the customer for making a customer payment for the service of the historic onboarding process of the historic onboarding training data set (e.g., success or failure of getting an authorized payment from the customer for the service)) as a training output or truth (e.g., failure (e.g., value 0) or success (e.g., value 1)). Such training for a particular CSCP model 602bm may be repeated using any suitable number of historic onboarding training data sets, where each historic onboarding training data set used to train a particular CSCP model 602bm may be related to one another in any suitable way(s), such as by being data indicative of an onboarding process for a particular service, such that each CSCP model may be for a particular service (e.g., a music subscription service, a cloud storage service, a movie subscription service, etc.). Additionally or alternatively, different CSCP models 602bm may be trained using respective different types of historic onboarding training data sets with respect to one or more types of training inputs (e.g., a first CSCP model for a particular service may be trained using historic onboarding training data sets indicative of an onboarding process in which a free trial window of a first length was utilized, a second CSCP model for a particular service may be trained using historic onboarding training data sets indicative of an onboarding process in which a free trial window of a second length different than the first length was utilized, and so on, such that a particular service may have multiple trained CSCP models, each one associated with a respective free trial window length (or length range)).

At operation 602c, one or more suitable parameters (e.g., hyperparameter(s)) may be determined (e.g., for use in one or more operations of the online portion of process 600). For example, a different CSIP threshold θ_{STAY} may be determined at operation 602c for each CSIP model 602am trained at operation 602a, and such a CSIP threshold θ_{STAY} may be used in a comparison (e.g., at operation 616 of process 600) with a predicted CSIP or P_{STAY} probability output (e.g., at operation 612 of process 600) from the associated CSIP model when run using model input features defined by onboarding data for a current online onboarding of a particular customer for a particular service. Such a CSIP threshold θ_{STAY} may be determined for a particular CSIP model 602am by grid search or parameter sweeping or any other suitable hyperparameter optimization technique of varying at least the CSIP threshold θ_{STAY} in order to optimize one or more characteristics of process 600 (e.g., to delay a credential authorization request during a customer onboarding process and/or to reduce or attempt to minimize the number of authorization requests made during a customer onboarding process and/or to increase or attempt to maximize the number of successful authorization requests and/or otherwise to improve or optimize or maximize or increase the success rate of each authorization request (e.g., for reducing costs associated with carrying out an authorization request) and/or customize a free trial length to increase or attempt to maximize the effectiveness of such a free trial (e.g., to promote customer engagement and intention for retention of the service (e.g., customer decision to pay for continuation of the service))). Such a comparison (e.g., at operation 616) may provide a constraint to limit when a customer transaction credential authorization request may be carried out during the customer onboarding process (e.g., at operation 622 of process 600), for example, to delay a credential authorization request during the customer onboarding process and/or to reduce or attempt to minimize the number of authorization requests made during the customer onboarding process and/or to otherwise make the onboarding process faster, more seamless, more efficient, and/or more effective. Grid search of the threshold may provide appropriate cost/benefit analysis.

Additionally or alternatively, a different CSCP threshold θ_{PAY} may be determined at operation 602c for each CSCP model 602bm trained at operation 602b, and such a CSCP threshold θ_{PAY} may be used in a comparison (e.g., at operation 618 and/or operation 630 of process 600) with a predicted CSCP or P_{PAY} probability output (e.g., at operation 610 and/or operation 628 of process 600) from the associated CSCP model when run using model input features defined by onboarding data for a current online onboarding of a particular customer for a particular service. Such a CSCP threshold θ_{PAY} may be determined for a particular CSCP model 602bm by grid search or parameter sweeping or any other suitable hyperparameter optimization technique of varying at least the CSCP threshold θ_{PAY} in order to optimize one or more characteristics of process 600 (e.g., to delay a credential authorization request during a customer onboarding process and/or to reduce or attempt to minimize the number of authorization requests made during a customer onboarding process and/or to increase or attempt to maximize the number of successful authorization requests and/or otherwise to improve or optimize or maximize or increase the success rate of each authorization request (e.g., for reducing costs associated with carrying out an authorization request) and/or customize a free trial length to increase or attempt to maximize the effectiveness of such a free trial (e.g., to promote customer engagement and intention for retention of the service (e.g., customer decision to pay for continuation of the service))). Such a comparison (e.g., at operation 618 and/or operation 630) may provide a constraint to limit when a customer transaction credential authorization request may be carried out during the customer onboarding process (e.g., at operation 622 and/or operation 634 of process 600), for example, to delay a credential authorization request during the customer onboarding process and/or to reduce or attempt to minimize the number of authorization requests made during the customer onboarding process and/or to otherwise make the onboarding process faster, more seamless, more efficient, and/or more effective. Grid search of the threshold may provide appropriate cost/benefit analysis.

Additionally or alternatively, a different set of functionalities CSIP-TL function ƒ_{STAY} and CSCP-TL function ƒ_{PAY} may be determined at operation 602c for each set of associated models CSIP model 602am and CSCP model 602bm trained at operations 602a and 602b (e.g., associated due to being trained on onboarding data for the same service and/or same trial window length), where such functionalities ƒ_{STAY} and θ_{PAY} may be used at least partially (e.g., in addition to P_{STAY} and P_{PAY} as output by the models associated with the functionalities (e.g., at operations 610 and 612)) to determine (e.g., at operation 614 of process 600) a customized free trial length TL for a free trial window to be provided to the customer being onboarded (e.g., at operation 620 and/or operation 624 of process 600). Such a set of functionalities ƒ_{STAY} and ƒ_{PAY} may be determined for an associated set of models 602am and 602bm (e.g., a general model or a TL-specific model) by trial and error or grid search or parameter sweeping or any other suitable hyperparameter optimization technique of varying at least the functionalities ƒ_{STAY} and ƒ_{PAY} or otherwise determining how a customized free trial length TL ought to be determined in order to optimize one or more characteristics of process 600 (e.g., to customize a free trial length to increase or attempt to maximize the effectiveness of such a free trial (e.g., to promote customer engagement and intention for retention of the service (e.g., customer decision to pay for continuation of the service))), such as by discovering a relationship between associated P_{STAY} and P_{PAY} and TL for providing the best onboarding conversion rate (or any other suitable key performance indicator(s) (“KPI(s)”)). Such functionalities ƒ_{STAY} and ƒ_{PAY} in combination with outputs P_{STAY} and P_{PAY} of associated CSIP and CSCP models for determining a customized free trial length TL for the current onboarding process (e.g., at operation 614) may provide an adaptation or personalization or customization to a free trial window offered to a particular customer for a particular service of the current onboarding, for example, to increase or attempt to maximize the effectiveness of such a free trial (e.g., to promote customer engagement and intention for retention of the service (e.g., customer decision to pay for continuation of the service)), and/or to otherwise make the onboarding process faster, more seamless, more efficient, and/or more effective. Trial and error or grid search or otherwise of the functionalities or otherwise of the customized length calculation may provide appropriate cost/benefit analysis.

At operation 604, it may be determined whether a particular customer has attempted to initiate a sign up for a particular service (e.g., whether a customer user of device 100 has selected a specific icon labeled with a “Music Service” or “MS” (or other suitable service) textual indicator of screen 190 of FIG. 3, in which case device 100 may launch or otherwise access a specific music (or other suitable service) subscription application and may display screens of a specific user interface that may include one or more tools or features for interacting with such a music (or other suitable service) subscription application for enabling the customer to initiate sign-up, such as by proceeding from screen 190 of FIG. 3 to a service sign-up initiation screen 190a of FIG. 3A that may be used by the customer to select a particular service type to sign up for and then to an optional customer log-in screen 190b of FIG. 3B that may be used by the customer to provide any suitable log-in information such that any suitable customer identifier data may be accessed (e.g., by the SP or manager of the one or more appropriate applications that may be carrying out the process)). If such a customer attempt is not detected at operation 604, such an operation 64 may be repeated until such a customer attempt is detected, all the while, operation 602 may also be repeated offline for continuously retraining any suitable models with any new onboarding data and/or redetermining any suitable parameters. However, if such a customer attempt is detected at operation 604, whereby the customer may proceed through screen 190a and/or 190b and/or otherwise, then process 600 may proceed from operation 604 to operation 606, where any suitable online features of the customer may be aggregated (e.g., through a customer logging-in at screen 190b or otherwise) and any suitable offline components that may be relevant to the customer and/or to the service of the onboarding may be loaded (e.g., any suitable CSIP model(s) 602am of operation 602a and/or any suitable CSCP model(s) 602bm of operation 602b and/or any suitable determined parameters of operation 602c). At operation 608, it may be determined whether or not the customer is eligible for a free trial of the service and, if so, what limitations, if any, there may be on such a free trial (e.g., maximum length of the free trial, possible options for a length of the free trial, etc.). Such a determination may be made based on any suitable rules or guidelines that may be provided by the SP of the service and/or based on any suitable accessible features of the customer. For example, a cloud storage service may be defined to enable a free trial service of no more than 180 days for all customers using a particular type of customer device but no free trial service at all for customers using another type of customer device, a music service may allow a free trial service of no more than 60 days if the customer initiates sign-up during the last two weeks of December or a free trial service of no more than 30 days if the customer initiates sign-up during the first two weeks of January but no free trial service at all if the customer initiates sign-up at other times, and/or based on any other suitable rules and/or characteristics of the customer (e.g., if the customer previously was provided a free trial for the same or similar service). If it is determined at operation 608 that the customer is eligible for a free trial of the service, then process 600 may proceed to operation 610. However, if it is determined at operation 608 that the customer is not eligible for a free trial of the service, then process 600 may proceed to operation 628.

When it is determined at operation 608 that the customer is eligible for a free trial of the service, then, at operation 610, one or more appropriate CSCP models 602bm (e.g., as trained at operation 602b) may be run utilizing any or all suitable onboarding data input features as may be available for the particular customer being onboarded for the particular service (e.g., any suitable UF, BF, TF, and/or TL data (e.g., as may be aggregated at operation 606)) in order to determine one or more particular capability probability P PAYS for the current customer onboarding. For example, in some embodiments, at operation 610, only a single general (e.g., non-TL-specific) CSCP model 602bm may be run to determine a single general P_{PAY} (e.g., P_{PAY-GENERAL}) for the current customer onboarding. Alternatively or additionally, at operation 610, any suitable number of different (e.g., different TL-specific) CSCP models 602bm may be run to determine different TL-specific P_{PAYS} for the current customer onboarding, for example, based on any free trial window limitations that may have been determined at operation 608 (e.g., if the free trial may be no greater than 180 days, then six (6) different CSCP models 602bm that have been trained for each one of respective free trial window lengths of 30 days, 60 days, 90 days, 120 days, 150 days, and 180 days (e.g., models CSCPM₃₀, CSCPM₆₀, CSCPM₉₀, CSCPM₁₂₀, CSCPM₁₅₀, and CSCPM₁₈₀) may be used to determine six (6) different P_{PAYS} (e.g., P_{PAY-30}, P_{PAY-60}, P_{PAY-90}, P_{PAY-120}, P_{PAY-150}, and P_{PAY-180})).

Moreover, when it is determined at operation 608 that the customer is eligible for a free trial of the service, then, before, after, or at least partially contemporaneously with operation 610, at operation 612, one or more appropriate CSIP models 602am (e.g., as trained at operation 602a) may be run utilizing any or all suitable onboarding data input features as may be available for the particular customer being onboarded for the particular service (e.g., any suitable UF, BF, TF, and/or TL data (e.g., as may be aggregated at operation 606)) in order to determine one or more particular intention probability P_{STAYS} for the current customer onboarding. For example, in some embodiments, at operation 612, only a single general (e.g., non-TL-specific) CSIP model 602am may be run to determine a single general P_{STAY} (e.g., P_{STAY-GENERAL}) for the current customer onboarding. Alternatively or additionally, at operation 612, any suitable number of different (e.g., different TL-specific) CSIP models 602am may be run to determine different TL-specific P_{STAYS} for the current customer onboarding, for example, based on any free trial window limitations that may have been determined at operation 608 (e.g., if the free trial may be no greater than 180 days, then six (6) different CSIP models 602am that have been trained for each one of respective free trial window lengths of 30 days, 60 days, 90 days, 120 days, 150 days, and 180 days (e.g., models CSIPM₃₀, CSIPM₆₀, CSIPM₉₀, CSIPM₁₂₀, CSIPM₁₅₀, and CSIPM₁₈₀) may be used to determine six (6) different P_{STAYS} (e.g., P_{STAY-30}, P_{STAY-60}, P_{STAY-90}, P_{STAY-120}, P_{STAY-150}, and P_{STAY-180})).

Then, after operations 610 and 612, a customized free trial length TL may be determined for the current customer onboarding at operation 614 using any suitable information, including, but not limited to, one, some, each P_{PAY} as determined at operation 610, one, some, each P_{STAY} as determined at operation 612, any suitable CSIP threshold(s) θ_{STAY} and/or any suitable CSCP threshold(s) θ_{PAY} and/or any suitable CSIP-TL functionality(ies) ƒ_{STAY} and/or any suitable CSCP-TL functionality(ies) ƒ_{PAY} as determined at operation 602c, any maximum free trial window length TL_{MAX} (e.g., as determined at operation 608), and/or the like. As just one particular example, the following particular customization trial length equation (1) may be utilized at operation 614 to calculate a customized free trial length TL, such as when only a single general P_{PAY} (e.g., P_{PAY-GENERAL}) and only a single general P_{STAY} (e.g., P_{STAY-GENERAL}) may be determined at respective operations 610 and 612 (e.g., via respective models CSCPM_{GENERAL} and CSIPM_{GENERAL}):

TL=TL_{MAX}*ƒ_{STAY-GENERAL}(P_{STAY-GENERAL})*ƒ_{PAY-GENERAL}(P_{PAY-GENERAL}). (1)

In such examples, each functionality may be determined to be any suitable functionality type. For example, each one of ƒ_{STAY-GENERAL} and ƒ_{PAY-GENERAL} may be defined to be linear functionalities, Whereby ƒ_{STAY-GENERAL}(P_{STAY-GENERAL})=P_{STAY-GENERAL} and ƒ_{PAY-GENERAL}(P_{PAY-GENERAL})=P_{PAY-GENERAL}, such that the more that the customer is determined to be willing to stay (e.g., the greater the P_{STAY-GENERAL}), the linearly greater the customized free trial length TL calculated by equation (1), and/or such that the more that the customer is determined to be willing to pay (e.g., the greater the P_{PAY-GENERAL}), the linearly greater the customized free trial length TL calculated by equation (1). As another example, while ƒ_{PAY-GENERAL} may be defined to be a linear functionality ƒ_{STAY-GENERAL} may be defined to be an inversely linear functionality, whereby ƒ_{STAY-GENERAL}(P_{STAY-GENERAL})=(1−P_{STAY-GENERAL}), such that the more that the customer is determined to be willing to stay (e.g., the greater the P_{STAY-GENERAL}), the linearly smaller the customized free trial length TL calculated by equation (1) (e.g., in order to provide a smaller free trial window if the customer is predicted to be more inclined to retain the service after the free trial). As yet another example, one or each of ƒ_{STAY-GENERAL} and ƒ_{PAY-GENERAL} may be defined to be a complex functionality, such as an exponential functionality, whereby ƒ_{STAY-GENERAL}(P_{STAY-GENERAL})=(1/(1+e^{(-5*PSTAY-GENERAL)})) such that the more that the customer is determined to be willing to stay (e.g., the greater the P_{STAY-GENERAL}), the exponentially greater the customized free trial length TL calculated by equation (1), and/or such as a step functionality, whereby ƒ_{PAY-GENERAL}(P_{PAY-GENERAL})=P_{PAY-GENERAL} if P_{PAY-GENERAL}≥θ_{PAY-GENERAL} or ƒ_{PAY-GENERAL}(P_{PAY-GENERAL})=0.5 if P_{PAY-GENERAL}<θ_{PAY-GENERAL}, such that if the customer is determined to be willing to stay at least a threshold amount, the step-wise greater the customized free trial length TL calculated by equation (1). Such an equation and/or such functionalities and/or other variables of such equations for calculating a customized trial length TL may be fine-tuned and/or experimented with (e.g., offline (e.g., at operation 602c)) prior to operation 614 and/or may vary based on the particular service of the onboarding. Such functionalities ƒ_{STAY-GENERAL} and ƒ_{PAY-GENERAL} in combination with outputs P_{STAY-GENERAL} and P_{PAY-GENERAL} of associated CSIP and CSCP general models for determining a customized free trial length TL for the current onboarding process (e.g., at operation 614) may provide an adaptation or personalization or customization to a free trial window offered to a particular customer for a particular service of the current onboarding, for example, to increase or attempt to maximize the effectiveness of such a free trial (e.g., to promote customer engagement and intention for retention of the service (e.g., customer decision to pay for continuation of the service)) and/or to otherwise make the onboarding process faster, more seamless, more efficient, and/or more effective. Trial and error or grid search or otherwise of the functionalities or otherwise of the customized length calculation may provide appropriate cost/benefit analysis.

As just one other particular example, any suitable functionality(ies) ƒ_{SPECIFIC} may be determined at operation 602c (e.g., through conditional probability or feedback loop or any suitable grid search or trial and error or otherwise) and then utilized at operation 614 to calculate a customized free trial length TL when different CSIP models 602am may be run at operation 610 to determine different TL-specific P_{STAYS} for the current customer onboarding and when different CSCP models 602bm may be run at operation 612 to determine different TL-specific P_{PAYS} for the current customer onboarding. For example, six (6) different CSIP models 602am may be trained for a respective one of six (6) different possible free trial window lengths of 30 days, 60 days, 90 days, 120 days, 150 days, and 180 days (e.g., models CSIPM₃₀, CSIPM₆₀, CSIPM₉₀, CSIPM₁₂₀, CSIPM₁₅₀, and CSIPM₁₈₀) and may then be used to determine six (6) different P_{STAYS} (e.g., P_{STAY-30}, P_{STAY-60}, P_{STAY-90}, P_{STAY-120}, P_{STAY-150}, and P_{STAY-180}), while six (6) different CSPP models 602bm may be trained for a respective one of six (6) different possible free trial window lengths of 30 days, 60 days, 90 days, 120 days, 150 days, and 180 days (e.g., models CSCPM₃₀, CSCPM₆₀, CSCPM₉₀, CSCPM₁₂₀, CSCPM₁₈₀, and CSCPM₁₈₀) and may then be used to determine six (6) different P_{PAYS} (e.g., P_{PAY-30}, P_{PAY-60}, P_{PAY-90}, P_{PAY-120}, P_{PAY-150}, and P_{PAY-180}). In such examples, a functionality ƒ_{SPECIFIC} may be used for carrying out a determination of a customization trial length equation (2) as follows:

TL=ƒ_{SPECIFIC}((P_{PAY-30},P_{PAY-60},P_{PAY-90},P_{PAY-120},P_{PAY-150},P_{PAY-180}), (P_{STAY-30},P_{STAY-60,}P_{STAY-90},P_{STAY-120},P_{STAY-150},P_{STAY-180})). (2)

In such an example, functionality ƒ_{SPECIFIC} may be determined to be any suitable functionality type. For example, functionality ƒ_{SPECIFIC} may be defined to select the TL associated with the particular one of the six (6) P_{PAY},P_{STAY} sets that generates the largest product (e.g., TL=30 days when (P_{PAY-30}*P_{STAY-30}) is larger than each one of (P_{PAY-60}*P_{STAY-60}) and (P_{PAY-90}*P_{STAY-90}) and (P_{STAY-120}*P_{STAY-120}) and (P_{STAY-150}*P_{STAY-150}) and (P_{STAY-180}*P_{STAY-180}), or TL=60 days when (P_{STAY-60}*P_{STAY-60}) is larger than each one of (P_{STAY-30}*P_{STAY-30}) and (P_{STAY-90}*P_{STAY-90}) and (P_{STAY-120}*P_{STAY-120}) and (P_{STAY-150}*P_{STAY-150}) and (P_{STAY-180}*P_{STAY-180}), etc.), such that, for example, the TL with the largest combined probability may be selected. As another example, functionality ƒ_{SPECIFIC} may be defined to select the TL associated with the particular one of the six (6) P_{PAY},P_{STAY} sets with the largest P_{STAY} (e.g., TL=30 days when P_{STAY-30} is larger than each one of P_{STAY-60} and P_{STAY-90} and P_{STAY-120} and P_{STAY-150} and P_{STAY-180}, or TL=60 days when P_{STAY-60} is larger than each one of P_{STAY-30} and P_{STAY-90} and P_{STAY-120} and P_{STAY-150} and P_{STAY-180}, etc.), such that, for example, the TL with the largest stay probability may be selected. As another example, functionality ƒ_{SPECIFIC} may be defined to select the TL associated with an average or median or otherwise of the TL associated with the largest one of the six (6) P_{PAYS} and the TL associated with the largest one of the six (6) P_{STAYS} (e.g., TL=60 days when not only P_{PAY-30} is greater than each one of P_{STAY-60} and P_{PAY-90} and P_{STAY-120} and P_{PAY-150} and P_{STAY-180} but also P_{STAY-90} is larger than each one of P_{STAY-30} and P_{STAY-60} and P_{STAY-120} and P_{STAY-150} and P_{STAY-180}, or TL=120 days when not only P_{STAY-60} is greater than each one of P_{PAY-30} and P_{PAY-90} and P_{PAY-120} and P_{PAY-150} and P_{PAY-180} but also P_{STAY-180} is larger than each one of P_{STAY-30} and P_{STAY-60} and P_{STAY-90} and P_{STAY-120} and P_{STAY-150}, etc. (e.g., the average of the TLs of the greatest P_{PAY} and the greatest P_{STAY})), such that, for example, the average or median of the TLs providing the greatest pay probability and the greatest stay probability. Such functionality ƒ_{SPECIFIC} in combination with outputs P_{STAY} and P_{PAY} of the associated CSIP and CSCP TL-specific models for determining a customized free trial length TL for the current onboarding process (e.g., at operation 614) may provide an adaptation or personalization or customization to a free trial window offered to a particular customer for a particular service of the current onboarding, for example, to increase or attempt to maximize the effectiveness of such a free trial (e.g., to promote customer engagement and intention for retention of the service (e.g., customer decision to pay for continuation of the service)) and/or to otherwise make the onboarding process faster, more seamless, more efficient, and/or more effective. Trial and error or grid search or otherwise of the functionality or otherwise of the customized length calculation may provide appropriate cost/benefit analysis. For an intention or stay model, a KPI or goal or training intent may be to increase or otherwise attempt to maximize the number of customers that pay for a service after a free trial (e.g., increase conversion rate) and/or to increase or otherwise attempt to maximize the length of a customer's engagement with a service after a free trial. For a capability or pay model, a KPI or goal or training intent may be to increase or otherwise attempt to maximize the number of customers that pay for a service after a free trial (e.g., increase conversion rate) and/or to increase or otherwise attempt to maximize the number of customers with successful deferred payment. Conditional probability and/or feedback loop or any suitable grid search or trial and error or otherwise may be utilized to determine any useful relationship between maximizing successful onboarding (e.g., increasing or otherwise attempting to maximize onboarding KPI(s)) with trial window length.

At operation 616, at least one particular P_{STAY}, as determined at operation 612 for the particular current onboarding using a particular CSIP model 602am trained at operation 602a, may be compared to a particular CSIP threshold θ_{STAY}, as determined at operation 602c for that particular CSIP model 602am, to determine whether that particular P_{STAY} is greater than or equal to that particular CSIP threshold θ_{STAY}, and, if so, process 600 may proceed from operation 616 to operation 618, otherwise, process 600 may proceed from operation 616 to operation 622. For example, when only a single general P_{STAY} (e.g., P_{STAY-GENERAL}) is determined at operation 612 (e.g., via a model CSIPM_{GENERAL}), then process 600 may advance from operation 616 to operation 618 when it is determined at operation 616 that P_{STAY-GENERAL} is greater than or equal to a CSIP threshold θ_{STAY-GENERAL} that may be determined to be associated with CSIPM_{GENERAL} at operation 602. Alternatively, when various different TL-specific P_{STAYS} (e.g., P_{STAY-30}, P_{STAY-60}, P_{STAY-90}, P_{STAY-120}, P_{STAY-150}, and P_{STAY-180}) are determined at operation 612 for various specific TLs (e.g., via respective TL-specific models CSIPM₃₀, CSIPM₆₀, CSIPM₉₀, CSIPM₁₂₀, CSIPM₁₅₀, and CSIPM₁₈₀), but a specific customized TL may be determined at operation 614, then process 600 may advance from operation 616 to operation 618 when it is determined at operation 616 that the P_{STAY} associated with that specific customized TL is greater than or equal to a specific CSIP threshold θ_{STAY} that may be determined at operation 602 to be associated with the CSIPM associated with that specific customized TL (e.g., when it is determined at operation 614 that the customized free trial length TL is 120 days, then process 600 may advance from operation 616 to operation 618 when it is determined at operation 616 that P_{STAY-120} is greater than or equal to a CSIP threshold θ_{STAY-120} that may be associated at operation 602c with CSIPM₁₂₀).

At operation 618, at least one particular P_{PAY}, as determined at operation 610 for the particular current onboarding using a particular CSCP model 602bm trained at operation 602b, may be compared to a particular CSCP threshold θ_{PAY}, as determined at operation 602c for that particular CSCP model 602bm, to determine whether that particular P_{PAY} is greater than or equal to that particular CSCP threshold θ_{PAY}, and, if so, process 600 may proceed from operation 618 to operation 620, otherwise, process 600 may proceed from operation 618 to operation 622. For example, when only a single general P_{PAY} (e.g., P_{PAY-GENERAL}) is determined at operation 610 (e.g., via a model CSCPM_{GENERAL}), then process 600 may advance from operation 618 to operation 620 when it is determined at operation 618 that P_{PAY-GENERAL} is greater than or equal to a CSCP threshold θ_{PAY-GENERAL} that may be determined to be associated with CSCPM_{GENERAL} at operation 602. Alternatively, when various different TL-specific P_{PAYS} (e.g., P_{PAY-30}, P_{PAY-60}, P_{PAY-90}, P_{PAY-120}, P_{PAY-150}, and P_{PAY-180}) are determined at operation 610 for various specific TLs (e.g., via respective IL-specific models CSCPM₃₀, CSCPM₆₀, CSCPM₉₀, CSCPM₁₂₀, CSCPM₁₅₀, and CSCPM₁₈₀), but a specific customized TL may be determined at operation 614, then process 600 may advance from operation 618 to operation 620 when it is determined at operation 618 that the P_{PAY} associated with that specific customized TL is greater than or equal to a specific CSCP threshold θ_{PAY} that may be determined at operation 602 to be associated with the CSCPM associated with that specific customized TL (e.g., when it is determined at operation 614 that the customized free trial length TL is 120 days, then process 600 may advance from operation 618 to operation 620 when it is determined at operation 618 that P_{PAY-120} is greater than or equal to a CSCP threshold θ_{PAY-120} that may be associated at operation 602c with CSCPM₁₂₀).

When the comparison of each one of operations 616 and 618 is successful (e.g., when the predicted likelihood of the customer to stay is greater than or equal to an applicable stay threshold and when the predicted likelihood of the customer to pay is greater than or equal to an applicable pay threshold), then process 600 may arrive at operation 620, where a free trial of customized length TL (e.g., as determined at operation 614) for at least a portion of the particular service of the current onboarding may be initiated and provided to the customer of the current onboarding (e.g., without requiring any successful attempt at a customer transaction credential authorization request for a customer transaction credential of the customer of the onboarding between operation 604 and operation 620). In such instances, the customer may be presented with any suitable new interface during the onboarding, such as by proceeding directly from screen 190a or screen 190b to a screen 190g of FIG. 3G, which may communicate to the customer that a free trial (e.g., of the determined customized length) has begun. At the end of such a free trial initiated at operation 620, a paid service may be initiated using a customer transaction credential that may have been authorized at any suitable moment during the onboarding process (e.g., prior to operation 620, at least partially concurrently with operation 620, or after operation 620) and a screen 190h of FIG. 3H may be presented to the customer, which may communicate to the customer that the free trial has ended but that the paid service has begun (e.g., using such an authorized credential). Alternatively, at the end of such a free trial initiated at operation 620, a paid service may not be initiated due to no customer transaction credential having yet been authorized at any suitable moment during the onboarding process (e.g., prior to operation 620, at least partially concurrently with operation 620, or after operation 620) and a screen 190i of FIG. 3I may be presented to the customer, which may communicate to the customer that the free trial has ended (or is about to end) but that the customer must identify a particular customer transaction credential for enabling a customer transaction credential authorization request attempt, which, when agreed to by the customer, may then lead to a screen 190d of FIG. 3D that may enable the customer to identify such a particular customer transaction credential (e.g., by either manually entering in various information indicative of such a credential (e.g., payment type, name, billing address, payment account number, etc.) or by selecting a customer transaction credential that may already be known to the service (e.g., as a result of the customer logging-in via screen 190b)), and, if such an attempt is successful, then a screen 190h may be presented to the customer indicating that the paid service has begun using that credential.

Therefore, while operation 620 may initially provide a customer with a free trial for the service, operation 620 may occur prior to a customer transaction credential being registered or authorized (e.g., an operation similar to operation 622 may be carried out after initiation of the free trial being provided to the customer (e.g., in order to speed up the process of providing service to the customer)), or operation 620 may occur after an initial attempt to register and/or authorize a customer transaction credential (e.g., an operation similar to operation 622 may be carried out prior to initiation of the free trial being provided to the customer at operation 620 but operation 620 may occur even if such an attempt were to fail (e.g., in order to speed up the process of providing service to the customer)). Thus, in some embodiments, as long as the predicted likelihood of the customer to pay is greater than or equal to an applicable pay threshold and the predicted likelihood of the customer to stay is greater than or equal to an applicable stay threshold, then a free trial of the service of the current onboarding may be initiated and provided to the customer of the current onboarding without requiring any successful attempt at a customer transaction credential authorization request for a customer transaction credential of the customer of the onboarding, such that the onboarding process may be furthered by providing the free trial of the service to the customer even if a customer transaction credential has not yet been authorized (e.g., between operation 604 and operation 620). In some embodiments, a customer transaction credential may be determined to be of record with (e.g., registered with) the SP prior to operation 620 (e.g., a credential previously used by the SP for some other purpose) even if that customer transaction credential is not authorized between operation 604 and operation 620. Therefore, registration of a customer transaction credential with the SP may be a requirement prior to operation 620 even if authorization of that or any other suitable customer transaction credential need not be accomplished prior to operation 620. Alternatively, in some embodiments, a customer transaction credential may need not be determined to be of record with (e.g., registered with) the SP prior to operation 620 (e.g., no credential of the customer may have previously been used by the SP for some other purpose) and a free trial for the service may be provided to the customer (e.g., at operation 620) with a calculated risk (e.g., at operation 618) that a customer transaction credential will eventually be registered and authorized (e.g., by providing the customer with a benefit of the doubt based on the success of operation 618). In some embodiments, the attempt to authorize a customer transaction credential at operation 622 may be in order to determine whether the customer transaction credential may be authorized at that moment in time. Alternatively, in some embodiments, the attempt to authorize a customer transaction credential at operation 622 may be in order to determine whether the customer transaction credential may be authorized at a moment in time once the free trial period ends (e.g., a length of time TL from the moment in time of operation 622) in order to ensure that the customer transaction credential will be valid once the customized trial length ends.

Alternatively, when the comparison of either one of operations 616 and 618 is not successful (e.g., when the predicted likelihood of the customer to stay is less than an applicable stay threshold and/or when the predicted likelihood of the customer to pay is less than an applicable pay threshold), then process 600 may arrive at operation 622, where an attempt may be made to authorize a customer transaction credential of the customer of the onboarding prior to providing the customer with a free trial of the determined customized length. In such instances, the customer may be presented with any suitable new interface during the onboarding for enabling such an attempt at a customer transaction credential authorization request, such as by proceeding directly from screen 190a or screen 190b to a screen 190c of FIG. 3C that may communicate to the customer that identification of a particular customer transaction credential must be made for enabling such an attempt at a customer transaction credential authorization request, which, when agreed to by the customer, may then lead to a screen 190d of FIG. 3D that may enable the customer to identify such a particular customer transaction credential (e.g., by either manually entering in various information indicative of such a credential (e.g., payment type, name, billing address, payment account number, etc.) or by selecting a customer transaction credential that may already be known to the service (e.g., as a result of the customer logging-in via screen 190b)). When such a customer transaction credential is identified (e.g., via screen 190d), the authorization request attempt may be made at operation 622 (e.g., through any suitable communication with an appropriate CM subsystem 300), which may then lead either to presentation of a screen 190e of FIG. 3E that may indicate to the customer that the authorization request for the identified customer transaction credential was a success or to presentation of a screen 190f of FIG. 3F that may indicate to the customer that the authorization request for the identified customer transaction credential was a failure. In the instances of a success at operation 622, screen 190e may be presented to present to the customer the option to cancel the onboarding or to continue the onboarding such that process 600 may proceed from operation 622 to operation 624 and to the presentation of screen 190g of FIG. 3G, which may communicate to the customer that a free trial of the determined customized length has begun, and at the end of such a free trial, a paid service may be initiated using the credential authorized at operation 622 (or any other credential (e.g., as may be selected by the customer)), and a screen 190h of FIG. 3H may be presented to the customer, which may communicate to the customer that the free trial has ended (or is about to end) but that the paid service has begun (or is about to begin) using the credential authorized at operation 622. However, in the instances of a failure at operation 622, process 600 may proceed from operation 622 to operation 626 where the onboarding sign-up may be denied (e.g., due to failure to authorize a credential for a customer determined to have a less than suitable likelihood of staying and/or a less than suitable likelihood of paying), and screen 190f may be presented to present to the customer the option to cancel the onboarding or to continue the onboarding by selecting another credential for another authorization attempt (e.g., by then returning to a new iteration of screen 190c and/or screen 190d). Therefore, in some embodiments, even though the predicted likelihood of the customer to pay may be less than an applicable pay threshold and/or even though the predicted likelihood of the customer to stay may be less than an applicable stay threshold, a free trial of the service of the current onboarding may be initiated and provided to the customer of the current onboarding as long as a customer transaction credential is first authorized.

When it is determined at operation 608 that the customer is not eligible for a free trial of the service, then, at operation 628, one or more appropriate CSCP models 602bm (e.g., as trained at operation 602b) may be run utilizing any or all suitable onboarding data input features as may be available for the particular customer being onboarded for the particular service (e.g., any suitable UF, BF, TF, and/or TL data) in order to determine one or more particular capability probability P_{PAYS} for the current customer onboarding. For example, in some embodiments, at operation 628, only a single general (e.g., a non-TL-specific or a zero-length-TL-specific) CSCP model 602bm may be run to determine a single P_{PAY} (e.g., P_{PAY-GENERAL} or a P_{PAY-0}) for the current customer onboarding. Alternatively or additionally, at operation 628, any suitable number of different (e.g., different TL-specific) CSCP models 602bm may be run to determine different TL-specific P_{PAYS} for the current customer onboarding, for example, based on any free trial window limitations that may have been determined at operation 608, yet this may be unlikely or unnecessary as a free trial window is not being offered when flowing through operation 628.

After operation 628, process 600 may proceed to operation 630, at which at least one particular P_{PAY}, as determined at operation 628 for the particular current onboarding using a particular CSCP model 602bm trained at operation 602b, may be compared to a particular CSCP threshold θ_{PAY}, as determined at operation 602c for that particular CSCP model 602bm, to determine whether that particular P_{PAY} is greater than or equal to that particular CSCP threshold θ_{PAY}, and, if so, process 600 may proceed from operation 630 to operation 632, otherwise, process 600 may proceed from operation 630 to operation 634. For example, when only a single general P_{PAY} (e.g., P_{PAY-GENERAL} or a P_{PAY-0}) is determined at operation 628 (e.g., via a model CSCPM_{GENERAL} or via a model CSCPM₀), then process 600 may advance from operation 630 to operation 632 when it is determined at operation 630 that P_{PAY-GENERAL} is greater than or equal to a CSCP threshold θ_{PAY-GENERAL} that may be determined to be associated with CSCPM_{GENERAL} at operation 602 or when it is determined at operation 630 that P_{PAY-0} is greater than or equal to a CSCP threshold θ_{PAY-0} that may be determined to be associated with CSCPM₀ at operation 602. Alternatively, when various different TL-specific P_{PAYS} are determined at operation 628 for various specific TLs, then process 600 may advance from operation 630 to operation 632 when it is determined at operation 630 that any particular P_{PAY} or function thereof that may be derived at operation 628 is greater than or equal to a particular or any suitable derivation of a CSCP threshold θ_{PAY}.

When the comparison of operation 630 is successful (e.g., when the predicted likelihood of the customer to pay is greater than or equal to an applicable pay threshold), then process 600 may arrive at operation 632, where a service to be paid for, or a service that has been paid for, of the particular service of the current onboarding may be initiated and provided to the customer of the current onboarding (e.g., without requiring any successful attempt at a customer transaction credential authorization request for a customer transaction credential of the customer of the onboarding between operation 604 and operation 632). In such instances, the customer may be presented with any suitable new interface during the onboarding, such as by proceeding directly from screen 190a or screen 190b to a screen 190j of FIG. 3J, which may communicate to the customer that at least a portion of the service of interest is now available to the customer. Actual payment for the service initiated at operation 632 may be initiated using a customer transaction credential that may have been authorized at any suitable moment during the onboarding process (e.g., prior to operation 632, at least partially concurrently with operation 632, or after operation 632) and a screen similar to screen 190j may be presented to the customer, which may communicate to the customer that the service is being provided or is otherwise available and that payment for the service has been made or will be made (e.g., using such an authorized credential). Alternatively, at some point after the service to be paid for has been initially made available to the customer at operation 632, the service may be terminated, or indication may be made to the customer that such a termination is imminent, due to no customer transaction credential having yet been authorized at any suitable moment during the onboarding process (e.g., prior to operation 632, at least partially concurrently with operation 632, or after operation 632) and a screen similar to screen 190i of FIG. 3I, but with reference to actual service rather than a free trial, may be presented to the customer, which may communicate to the customer that the service being provided has ended (or is about to end) but that the customer must identify a particular customer transaction credential for enabling a customer transaction credential authorization request attempt, which, when agreed to by the customer, may then lead to a screen 190d of FIG. 3D that may enable the customer to identify such a particular customer transaction credential (e.g., by either manually entering in various information indicative of such a credential (e.g., payment type, name, billing address, payment account number, etc.) or by selecting a customer transaction credential that may already be known to the service (e.g., as a result of the customer logging-in via screen 190b)), and, if such an attempt is successful, then a screen similar to screen 190h may be presented to the customer indicating that the paid service has been restored or will continue due to payment using that credential. Therefore, while operation 632 may initially provide a customer with a service to be paid for, operation 632 may occur prior to a customer transaction credential being registered or authorized (e.g., an operation similar to operation 634 may be carried out after initiation of service being provided to the customer (e.g., in order to speed up the process of providing service to the customer)), or operation 632 may occur after an initial attempt to register and/or authorize a customer transaction credential (e.g., an operation similar to operation 634 may be carried out prior to initiation of service being provided to the customer at operation 632 but operation 632 may occur even if such an attempt were to fail (e.g., in order to speed up the process of providing service to the customer)).

Thus, in some embodiments, as long as the predicted likelihood of the customer to pay is greater than or equal to an applicable pay threshold, then a service of the current onboarding to be paid for may be initiated and provided to the customer of the current onboarding without requiring any successful attempt at a customer transaction credential authorization request for a customer transaction credential of the customer of the onboarding, such that the onboarding process may be furthered by providing service to the customer even if a customer transaction credential has not yet been authorized. In some embodiments, a customer transaction credential may be determined to be of record with the SP prior to operation 632 (e.g., a credential previously used by the SP for some other purpose) even if that customer transaction credential is not authorized between operation 604 and operation 632. Therefore, registration of a customer transaction credential with the SP may be a requirement prior to operation 632 even if authorization of that or any other suitable customer transaction credential need not be accomplished prior to operation 632. Alternatively, in some embodiments, a customer transaction credential may need not be determined to be of record with the SP prior to operation 632 (e.g., no credential of the customer may have previously been used by the SP for some other purpose) and a to-be-paid for service may be provided to the customer (e.g., at operation 632) with a calculated risk (e.g., at operation 630) that payment will eventually be made (e.g., by providing the customer with a benefit of the doubt based on the success of operation 630).

Alternatively, when the comparison of operation 630 is not successful (e.g., when the predicted likelihood of the customer to pay is less than an applicable pay threshold), then process 600 may arrive at operation 634, where an attempt may be made to authorize a customer transaction credential of the customer of the onboarding prior to providing the customer with at least a portion of the service. In such instances, the customer may be presented with any suitable new interface during the onboarding for enabling such an attempt at a customer transaction credential authorization request, such as by proceeding directly from screen 190a or screen 190b to a screen 190c of FIG. 3C that may communicate to the customer that identification of a particular customer transaction credential must be made for enabling such an attempt at a customer transaction credential authorization request, which, when agreed to by the customer, may then lead to a screen 190d of FIG. 3D that may enable the customer to identify such a particular customer transaction credential (e.g., by either manually entering in various information indicative of such a credential (e.g., payment type, name, billing address, payment account number, etc.) or by selecting a customer transaction credential that may already be known to the service (e.g., as a result of the customer logging-in via screen 190b)). When such a customer transaction credential is identified (e.g., via screen 190d), the authorization request attempt may be made at operation 634 (e.g., through any suitable communication with an appropriate CM subsystem 300), which may then lead either to presentation of a screen 190e of FIG. 3E that may indicate to the customer that the authorization request for the identified customer transaction credential was a success or to presentation of a screen 190f of FIG. 3F that may indicate to the customer that the authorization request for the identified customer transaction credential was a failure. In the instances of a success of authorization at operation 634, screen 190e may be presented to present to the customer the option to cancel the onboarding or to continue the onboarding such that process 600 may proceed from operation 634 to operation 636 and to the presentation of a screen similar to screen 190j, which may communicate to the customer that the service is being provided or is otherwise available and that payment for the service has been made or will be made (e.g., using the credential authorized at operation 634 (or any other credential (e.g., as may be selected by the customer)). However, in the instances of a failure at operation 634, process 600 may proceed from operation 634 to operation 638 where the onboarding sign-up may be denied (e.g., due to failure to authorize a credential for a customer determined to have a less than suitable likelihood of paying), and screen 190f may be presented to present to the customer the option to cancel the onboarding or to continue the onboarding by selecting another credential for another authorization attempt (e.g., by then returning to a new iteration of screen 190c and/or screen 190d). Therefore, in some embodiments, even though the predicted likelihood of the customer to pay is less than an applicable pay threshold, a service of the current onboarding to be paid for may be initiated and provided to the customer of the current onboarding as long as a customer transaction credential is first authorized.

It is understood that the operations shown in process 600 of FIG. 6 are only illustrative and that existing operations may be modified or omitted, additional operations may be added, and the order of certain operations may be altered. For example, operation 608 may at least be initiated or completed prior to operation 606 such that the result of operation 608 may at least partially dictate operation 606 (e.g., only one or more CSCP models and no CSIP models may be loaded at operation 606 if it is determined at operation 608 that no free trial window is possible). Additionally or alternatively, operation 610 may be delayed until after operation 616. Additionally or alternatively, operation 614 may be delayed until after operation 618 but, perhaps, prior to operation 620. Additionally or alternatively, operation 614 may be delayed until after operation 622 but, perhaps, prior to operation 624. In some embodiments, the order of operations 616 and 618 may be swapped. In some embodiments, operation 622 may be reached in response to a determination of any suitable combination of results from operations 616 and 618 (e.g., if either one of operations 616 and 618 fail and/or if the magnitude by which one of operations 616 and 618 fails is greater by any suitable degree or functionality than the magnitude by which the other one of operations 616 and 618 fails and/or the like).

Therefore, SP subsystem 200 may be configured to provide a new layer of efficiency and/or effectiveness and/or control to customer onboarding by customizing one or more aspects of an onboarding process (e.g., the length of a free trial and/or under what circumstances may a free trial or a to-be-paid-for service be provided to a customer prior to authorizing a customer transaction credential) afforded by the SP subsystem to a particular customer for a particular service for delaying a credential authorization request during the customer onboarding process and/or for reducing or attempting to minimize the number of authorization requests made during the customer onboarding process and/or for increasing or attempt to maximize the number of successful authorization requests and/or otherwise for improving or optimizing or maximizing or increasing the success rate of each authorization request (e.g., for reducing costs associated with carrying out an authorization request) and/or for increasing or attempting to maximize the effectiveness of a free trial (e.g., to promote customer engagement and intention for retention of the service (e.g., customer decision to pay for continuation of the service)) and/or for otherwise making the onboarding process faster, more seamless, more efficient, and/or more effective. In some embodiments, customer transaction credential registration and/or authorization may be skipped prior to initiating the providing of a service or a free trial thereof to a customer during an onboarding process, for example, when a predicted likelihood of the customer to pay for the service is greater than or equal to an applicable pay threshold (e.g., when a P_{PAY} is determined to be greater than or equal to (or otherwise favorably compare with) an appropriate CSCP threshold θ_{STAY}), where such a predicted likelihood to pay may be a result of an output from any appropriately trained model using any suitable input features for the customer and/or service being onboarded (e.g., past history information associated with the customer (e.g., historical payment details of the customer (e.g., previous purchases and/or attempted purchases by the customer), etc.), etc.) and/or when a predicted likelihood of the customer to use the service is greater than or equal to an applicable stay threshold (e.g., when a P_{STAY} is determined to be greater than or equal to (or otherwise favorably compare with) an appropriate CSIP threshold θ_{STAY}), where such a predicted likelihood to stay may be a result of an output from any appropriately trained model using any suitable input features for the customer and/or service being onboarded. A free trial length may, thus, be customized with a goal of motivating the customer to stay and to pay. Using particular test/training onboarding data from previous onboarding attempts and/or any other suitable customer/service transactions of any suitable type with known outcomes, a customer service intention probability model may be generated/trained for appropriately predicting/determining the probability of a customer staying with a particular service and/or a customer service capability probability model may be generated/trained for appropriately predicting/determining the probability of a customer paying for a particular service. By creating one or more such models that have been generated using trusted test data, such model(s) may be relied on by the system to accurately predict one or more customer interactions during the onboarding process, which may enable server 210 to efficiently and effectively balance risk and reward for customizing the onboarding process for a particular customer for a particular service of a particular customer onboarding with an SP. In some embodiments, one or more such models may be updated and/or any suitable model input features may be updated for re-customizing the onboarding process during the onboarding itself (e.g., by reducing or expanding or terminating a free trial currently underway), such that onboarding may be further customized and dynamically adjusted to further mitigate risk by intelligently and efficiently updating the onboarding accordingly (e.g., by utilizing new data about the particular customer or otherwise).

### Further Description of FIGS. 1-6

One, some, or all of the processes described with respect to FIGS. 1-6 may each be implemented by software, but may also be implemented in hardware, firmware, or any combination of software, hardware, and firmware. Instructions for performing these processes may also be embodied as machine- or computer-readable code recorded on a machine- or computer-readable medium. In some embodiments, the computer-readable medium may be a non-transitory computer-readable medium. Examples of such a non-transitory computer-readable medium include but are not limited to a read-only memory, a random-access memory, a flash memory, a CD-ROM, a DVD, a magnetic tape, a removable memory card, and a data storage device (e.g., memory 104 of FIG. 2). In other embodiments, the computer-readable medium may be a transitory computer-readable medium. In such embodiments, the transitory computer-readable medium can be distributed over network-coupled computer systems so that the computer-readable code is stored and executed in a distributed fashion. For example, such a transitory computer-readable medium may be communicated from one electronic device or subsystem to another electronic device or subsystem using any suitable communications protocol (e.g., the computer-readable medium may be communicated to electronic device 100 via communications circuitry 114 (e.g., as at least a portion of an application 103 and/or as at least a portion of an application 103a)). Such a transitory computer-readable medium may embody computer-readable code, instructions, data structures, program modules, or other data in a modulated data signal, such as a carrier wave or other transport mechanism, and may include any information delivery media. A modulated data signal may be a signal that has one or more of its characteristics set or changed in such a manner as to encode information in the signal.

It is understood that any, each, or at least one module or component or subsystem of system 1 may be provided as a software construct, firmware construct, one or more hardware components, or a combination thereof. For example, any, each, or at least one module or component or subsystem of system 1 may be described in the general context of computer-executable instructions, such as program modules, that may be executed by one or more computers or other devices. Generally, a program module may include one or more routines, programs, objects, components, and/or data structures that may perform one or more particular tasks or that may implement one or more particular abstract data types. It is also to be understood that the number, configuration, functionality, and interconnection of the modules and components and subsystems of system 1 are only illustrative, and that the number, configuration, functionality, and interconnection of existing modules, components, and/or subsystems may be modified or omitted, additional modules, components, and/or subsystems may be added, and the interconnection of certain modules, components, and/or subsystems may be altered.

At least a portion of one or more of the modules or components or subsystems of system 1 may be stored in or otherwise accessible to an entity of system 1 in any suitable manner (e.g., in memory 104 of device 100 (e.g., as at least a portion of an application 103 and/or as at least a portion of an application 103a)). Any or all of the modules or other components of system 1 may be mounted on an expansion card, mounted directly on a system motherboard, or integrated into a system chipset component (e.g., into a “north bridge” chip).

Any or each module or component of system 1 may be a dedicated system implemented using one or more expansion cards adapted for various bus standards. For example, all of the modules may be mounted on different interconnected expansion cards or all of the modules may be mounted on one expansion card. Any or each module or component of system 1 may include its own processing circuitry and/or memory. Alternatively, any or each module or component of system 1 may share processing circuitry and/or memory with any other module.

As described above, one aspect of the present technology is the gathering and use of data available from various sources to customize authorization request schedules. The present disclosure contemplates that in some instances, this gathered data may include personal information data that uniquely identifies or can be used to contact or locate a specific person. Such personal information data can include demographic data, location-based data, telephone numbers, email addresses, social network identifiers, home addresses, office addresses, data or records relating to a user's health or level of fitness (e.g., vital signs measurements, medication information, exercise information, etc.) or purchase history, date of birth, or any other identifying or personal information.

The present disclosure recognizes that the use of such personal information data, in the present technology, can be used to the benefit of users. The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the United States, collection of or access to certain health data may be governed by federal and/or state laws, such as the Health Insurance Portability and Accountability Act (“HIPAA”); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of location detection services, the present technology can be configured to allow users to select to “opt in” or “opt out” of participation in the collection of personal information data during registration for services or anytime thereafter. In addition to providing “opt in” or “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, customizing customer onboarding can be made based on non-personal information data or a bare minimum amount of personal information, such as the content being requested by the device associated with a user, other non-personal information available to the device, or publicly available information.

While there have been described systems, methods, and computer-readable media for customizing customer onboarding, it is to be understood that many changes may be made therein without departing from the spirit and scope of the subject matter described herein in any way. Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

Therefore, those skilled in the art will appreciate that the invention can be practiced by other than the described embodiments, which are presented for purposes of illustration rather than of limitation.

What is claimed is:

1. A method for customizing, using a management server, an onboarding process afforded to a customer for a service of a service provider, the method comprising:
running, with the management server, a trained customer service intention probability (“CSIP”) model on current CSIP onboarding feature data associated with the onboarding of the customer for the service, wherein the running the trained CSIP model predicts an intention probability that is indicative of the likelihood of the customer to use the service;
running, with the management server, a trained customer service capability probability (“CSCP”) model on current CSCP onboarding feature data associated with the onboarding of the customer for the service, wherein the running the trained CSCP model predicts a capability probability that is indicative of the likelihood of the customer to pay for the service;
defining, with the management server, a customized free trial length using each one of the predicted intention probability and the predicted capability probability; and
providing, with the management server, a free trial of the customized free trial length to the customer for the service.

2. The method of claim 1, further comprising, prior to the providing, determining, with the management server, whether or not the predicted intention probability meets a CSIP threshold of the trained CSIP model, wherein the providing comprises providing the free trial of the customized free trial length to the customer for the service only when the predicted intention probability is determined to meet the CSIP threshold of the trained CSIP model.

3. The method of claim 1, further comprising, prior to the providing, determining, with the management server, whether or not the predicted capability probability meets a CSCP threshold of the trained CSCP model, wherein the providing comprises providing the free trial of the customized free trial length to the customer for the service only when the predicted capability probability is determined to meet the CSCP threshold of the trained CSCP model.

4. The method of claim 1, further comprising:
prior to the providing, determining, with the management server, whether or not the predicted intention probability meets a CSIP threshold of the trained CSIP model; and
prior to the providing, determining, with the management server, whether or not the predicted capability probability meets a CSCP threshold of the trained CSCP model, wherein the providing comprises providing the free trial of the customized free trial length to the customer for the service only when:
the predicted intention probability is determined to meet the CSIP threshold of the trained CSIP model; and
the predicted capability probability is determined to meet the CSCP threshold of the trained CSCP model.

5. The method of claim 1, wherein the intention probability is indicative of the likelihood of the customer to use the service after the providing the free trial.

6. The method of claim 1, wherein the capability probability is indicative of the likelihood of the customer to pay for the service after the providing the free trial.

7. The method of claim 1, wherein:
the intention probability is indicative of the likelihood of the customer to use the service after the providing the free trial; and
the capability probability is indicative of the likelihood of the customer to pay for the service after the providing the free trial.

8. The method of claim 1, wherein the current CSCP onboarding feature data comprises data indicative of at least one of the following:
a date on which a payment credential of the customer was associated with the customer at the management server;
a type of a payment credential associated with the customer at the management server;
a type of credential manager subsystem that manages a payment credential associated with the customer at the management server;
an expiration date of a payment credential associated with the customer at the management server;
the number of times the customer has updated billing information of a payment credential associated with the customer at the management server;
duration of time since the last time the customer updated billing information of a payment credential associated with the customer at the management server;
duration since last authorization request by the management server for a payment credential associated with the customer at the management server;
status of last authorization request by the management server for a payment credential associated with the customer at the management server;
type of last product purchased with a payment credential associated with the customer at the management server; or
cost of last product purchased with a payment credential associated with the customer at the management server.

9. The method of claim 1, wherein the current CSIP onboarding feature data comprises data indicative of at least one of the following:
duration of association between the customer and the service provider;
duration of association between the customer and the service;
device platform used by the customer to receive the service;
ratio of free versus paid purchases by the customer for the service provider;
a subscription price for the service;
a subscription length for the service; or
duration of a subscription gap by the customer for the service.

10. The method of claim 1, wherein the running the trained CSIP model comprises running, with the management server, a plurality of trained CSIP models on the current CSIP onboarding feature data associated with the onboarding of the customer for the service to predict a plurality of respective intention probabilities, wherein each trained CSIP model of the plurality of trained CSIP models is associated with a different particular free trial length, and wherein the intention probability predicted by a particular trained CSIP model of the plurality of trained CSIP models is indicative of the likelihood of the customer to use the service after a free trial of the particular free trial length associated with the particular trained CSIP model.

11. The method of claim 10, wherein the defining comprises defining, with the management server, the customized free trial length using each one of the plurality of predicted intention probabilities and the predicted capability probability.

12. The method of claim 1, wherein the running the trained CSCP model comprises running, with the management server, a plurality of trained CSCP models on the current CSCP onboarding feature data associated with the onboarding of the customer for the service to predict a plurality of respective capability probabilities, wherein each trained CSCP model of the plurality of trained CSCP models is associated with a different particular free trial length, and wherein the capability probability predicted by a particular trained CSCP model of the plurality of trained CSCP models is indicative of the likelihood of the customer to pay for the service after a free trial of the particular free trial length associated with the particular trained CSCP model.

13. The method of claim 12, wherein the defining comprises defining, with the management server, the customized free trial length using each one of the plurality of predicted capability probabilities and the predicted intention probability.

14. The method of claim 12, wherein the running the trained CSIP model comprises running, with the management server, a plurality of trained CSIP models on the current CSIP onboarding feature data associated with the onboarding of the customer for the service to predict a plurality of respective intention probabilities, wherein each trained CSIP model of the plurality of trained CSIP models is associated with a different particular free trial length, and wherein the intention probability predicted by a particular trained CSIP model of the plurality of trained CSIP models is indicative of the likelihood of the customer to use the service after a free trial of the particular free trial length associated with the particular trained CSIP model.

15. The method of claim 14, wherein the defining comprises defining, with the management server, the customized free trial length using each one of the plurality of predicted intention probabilities and each one of the plurality of predicted capability probabilities.

16. The method of claim 1, wherein the defining comprises defining, with the management server, the customized free trial length to be one of the following:
linear with each one of the predicted intention probability and the predicted capability probability;
linear with the predicted capability probability but inversely linear with the predicted intention probability; and
exponential with the predicted intention probability and step wise with the predicted capability probability.

17. The method of claim 1, comprising the providing without first attempting to authorize any payment credential associated with the customer at the management server.

18. A system for customizing an onboarding process, comprising:
a credential manager subsystem that manages a payment credential;
a service provider subsystem that offers a service; and
a user electronic device that attempts to access the service of the service provider subsystem for a user of the user electronic device, wherein the user has a user account with the service provider subsystem, wherein the payment credential is associated with the user account, and wherein the service provider subsystem is configured to:
detect the access attempt;
in response to the detection of the access attempt, run a trained learning engine on onboarding features of the access attempt to predict a likelihood of the user successfully paying for the service using the payment credential; and
when the predicted likelihood meets a likelihood threshold, automatically provide the service to the user via the user electronic device without first requesting, of the credential manager subsystem, an authorization of the payment credential for paying for the service.

19. The system of claim 18, wherein the service provider subsystem is further configured to:
determine whether or not the user is eligible for a free trial of the service; and
when it is determined that the user is eligible for a free trial of the service, calculate a length of a trial period based on the predicted likelihood, wherein the automatically provided service comprises a free trial for the calculated length.

20. A non-transitory machine readable medium storing a program for execution by at least one processing unit of a management server, the program for customizing an onboarding process afforded to a customer for a service, the program comprising sets of instructions for:
predicting, using a trained first model, a likelihood of the customer using the service;
predicting, using a trained second model that is different than the first model, a likelihood of the customer paying for the service;
calculating a length of a trial period based on each one of the predicted likelihood of the customer using the service and the predicted likelihood of the customer paying for the service; and
providing a trial of the calculated length to the customer for the service.
